(19) United States
(12) Patent Application Publication
(10) Pub. No.: US 2024/0202528 A1
(43) Pub. Date: Jun. 20, 2024

(54) WIRELESS SYSTEM EMPLOYING END-TO-END NEURAL NETWORK CONFIGURATION FOR DATA STREAMING

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 18/555,337

(22) PCT Filed: Apr. 13, 2022
(86) PCT No.: PCT/US2022/024584

§ 371 Date: Oct. 13, 2023

Related U.S. Application Data
(60) Provisional application No. 63/174,382, filed on Apr. 13, 2021.

(51) Int. Cl. G06N 3/082; G06N 3/04

(52) U.S. Cl. CPC G06N 3/082; G06N 3/04

(57) ABSTRACT

Systems and techniques provide for the joint training and implementation of an end-to-end chain of neural networks along the nodes of an at least partially wireless transmission path used to transmit a data stream between a data source device and at least one data sink device. The source-side neural networks of the chain can implement one or both of data encoding and channel encoding of outgoing data blocks, and the sink-side neural networks of the chain conversely can implement one or both of channel decoding and data decoding to provide efficient end-to-end transmission of the data stream without necessitating individual design, test, and implementation of discrete processes for each coding and decoding stage, while also facilitating the adaptation of the end-to-end neural network chaining process to various operational parameters.

### BACKGROUND

The transmission of a data stream between a data source device and a data sink device in a wireless system typically involves a transmission path with a sequence of nodes, with each node performing one or more processes on the signaling representative of the data of the stream. For example, for a video call being streamed between a first user equipment (UE) and a second UE, the video captured at the first UE is parsed into a stream of data blocks. Each data block is compressed using a video compression process and the resulting compressed data block is then channel encoded to generate an output signal suitable for radio frequency (RF) transmission to a first UE-facing infrastructure component, such as a base station, wireless local area network (WLAN) access point, and the like. The first UE-facing infrastructure component performs a decoding (and demodulation) process on the received RF signal to obtain the underlying data, which is then packetized and otherwise processed for network transmission via one or more network components to a second UE-facing infrastructure component. Each infrastructure component along the transmission path likewise depacketizes the incoming signal, performs various processes on the resulting data, and then repacketizes the result for further network transmission. The second UE-facing infrastructure component then performs additional processing on this received signal, including channel encoding the signal so that the resulting output can be transmitted via RF signaling to the second UE. The second UE decodes (and demodulates) the incoming signal to obtain the underlying compressed data block, and then decompresses the compressed data block to obtain the original uncompressed data block (or a lossy representation thereof depending on the compression/decompression process). The recovered data block then may be processed at the second UE for the display of the video content represented in the data block.

This sequence of processes from data generation at the first UE to data consumption at the second UE typically is implemented using a modular design approach in which each process is effectively individually “handcrafted” by one or more designers. The relative complexity of each process typically translates to commensurate complexity in designing, testing, and implementing a hard-coded implementation of the process. As such, it can be impractical to design and implement a robust process that is highly adaptable to changing conditions and highly efficient for reduced transmission latency. Moreover, oversight of the various devices in the transmission path may be split between multiple entities thus making it difficult to ensure that each device is capable of performing its corresponding processes in a manner that is fully compatible with the capabilities of the downstream devices or in a manner that is optimal for low-latency end-to-end transmission of the data stream.

### SUMMARY OF EMBODIMENTS

In one aspect, a method, in a data source device, includes receiving a first data block of a data stream as an input to a transmitter neural network of the data source device, generating, at the transmitter neural network, a first output based on the first data block, the first output representing a data encoded and channel encoded version of the first data block, and controlling a radio frequency (RF) antenna interface of the data source device based on the first output to transmit a first RF signal representative of the data encoded and channel encoded version of the first data block.

In another aspect, a computer-implemented method, in a data sink device, includes receiving, at a RF antenna interface of the data sink device, a first RF signal representative of a data encoded and channel encoded version of a first data block of a data stream, providing a first input representative of the first RF signal as an input to a receiver neural network of the data sink device, generating, at the receiver neural network, a first recovered data block representing a recovered channel decoded and data decoded version of the first data block, and providing the first recovered data block for processing at one or more software applications of the data sink device.

In yet another aspect, a computer-implemented method, in an infrastructure component of a network infrastructure, includes configuring a data source device to implement a first neural network architectural configuration for a transmitter neural network of the data source device, the transmitter neural network configured to generate, for each input data block of a data stream generated at the data source device, a corresponding output for transmission by a radio frequency (RF) antenna interface of the data source device, the corresponding output representing a data encoded and channel encoded version of the input data block, and configuring a data sink device to implement a second neural network architectural configuration for a receiver neural network of the data sink device, the receiver neural network configured to generate, for each input from an RF antenna interface of the data sink device, a corresponding data block for provision to one or more software applications of the data sink device, the corresponding data block representing a recovered channel decoded and data decoded version of a corresponding data block of the data stream.

A device may include a network interface, at least one processor coupled to the network interface, and a memory storing executable instructions, the executable instructions configured to manipulate the at least one processor to perform the method of any of the aspects described above.

A device may include an RF antenna interface, at least one processor coupled to the RF antenna interface, and a memory storing executable instructions, the executable instructions configured to manipulate the at least one processor to perform the method of any of the aspects described above.

### BRIEF DESCRIPTION OF THE DRAWINGS

The present disclosure is better understood and its numerous features and advantages made apparent to those skilled in the art by referencing the accompanying drawings. The use of the same reference symbols in different drawings indicates similar or identical items.

FIG. 1 is a diagram illustrating an example wireless system employing a jointly-trained end-to-end neural network chain for improved quality of experience (QoE) for data streams in accordance with some embodiments.

FIG. 2 is a diagram illustrating example hardware configurations of an end device of the wireless system of FIG. 1 in accordance with some embodiments.

FIG. 3 is a diagram illustrating example hardware configurations of a device-facing network infrastructure component of the wireless system of FIG. 1 in accordance with some embodiments.

FIG. 4 is a diagram illustrating an example hardware configuration of a managing infrastructure component of the wireless system of FIG. 1 in accordance with some embodiments.

FIG. 5 is a diagram illustrating a machine learning (ML) module employing a neural network for use in an end-to-end neural network chain in accordance with some embodiments.

FIG. 6 is a diagram illustrating an end-to-end neural network chain for the data encoding, channel encoding, transmission, channel decoding, and data decoding of a data block of a data stream transmitted between a data source device and a data sink device in a wireless system in accordance with some embodiments.

FIG. 7 is a flow diagram illustrating an example method for end-to-end joint training of a neural network chain in a wireless system in accordance with some embodiments.

FIG. 8 is a flow diagram illustrating an example method for wireless communication between a data source device and a data sink device in a wireless system using an end-to-end neural network chain in accordance with some embodiments.

FIG. 9 is a ladder signaling diagram illustrating an example operation of an initial DNN chain configuration process of the method of FIG. 8 in accordance with some embodiments.

FIG. 10 is a ladder signaling diagram illustrating an example operation of the end-to-end data transmission process of the method of FIG. 8 in accordance with some embodiments.

FIG. 11 is a block diagram illustrating an example wireless system employing an end-to-end neural network tree having multiple data sink devices in accordance with some embodiments.

FIG. 12 is a diagram illustrating an example cloud gaming system employing an end-to-end neural network chain in accordance with some embodiments.

### DETAILED DESCRIPTION

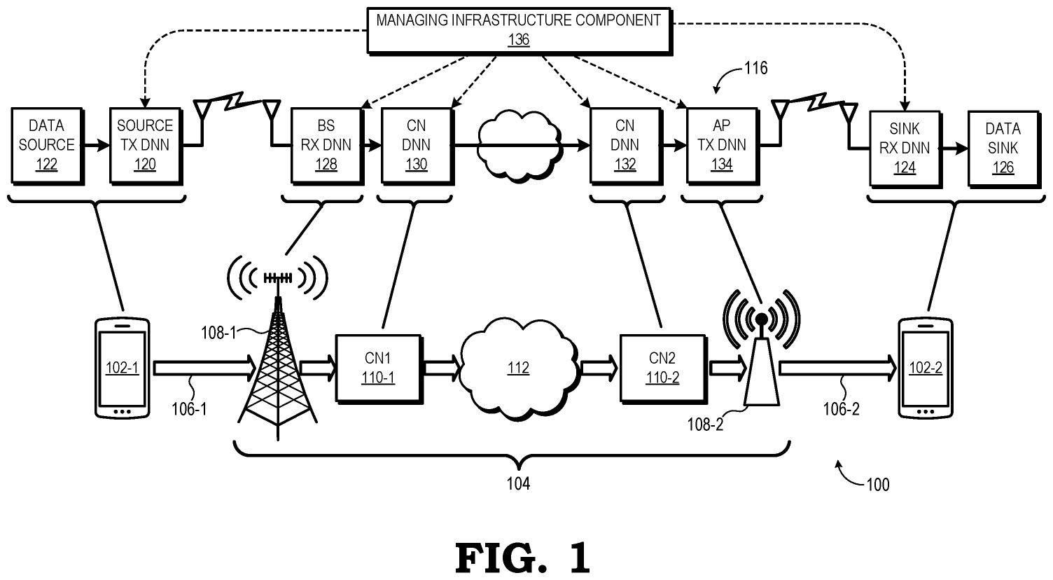

FIGS. 1-12 illustrate systems and techniques for the joint training and implementation of an end-to-end chain of neural networks along the nodes of an at least partially wireless transmission path used to transmit a data stream between a data source device and one or more data sink devices. The source-side neural networks of the chain can implement one or both of data encoding and channel encoding of outgoing data blocks and the sink-side neural networks of the chain conversely can implement one or both of channel decoding and data decoding so as to provide efficient end-to-end transmission of the data stream without necessitating individual design, test, and implementation of discrete processes for each coding and decoding stage, while also facilitating the adaptation of the end-to-end neural network chaining process to various operational parameters, such as RF operating environment parameters represented in captured sensor data, changes in capabilities of one or more nodes along the transmission path, and the like.

FIG. 1 illustrates a wireless communications system 100 employing an end-to-end neural network configuration for data streaming in accordance with some embodiments. The system 100 includes a data source device 102-1 connected to one or more data sink devices 102-2 via a network infrastructure 104 composed of various infrastructure components, such as base stations (BSs), wireless local area network (WLAN) access points (APs), core networks, non-core networks (e.g., the Internet), application servers, and the like. In operation, the data source device 102-1 generates an outgoing data stream 106-1 that is received and processed by the network infrastructure 104 to generate a corresponding incoming data stream 106-2 that is received, processed, and consumed by the data sink device 102-2, wherein the incoming data stream 106-2 is a lossy or lossless representation of the data content of the outgoing data stream 106-1 depending on implementation. Note that in bidirectional communication scenarios, such as when the system 100 is providing voice call or video call services between the devices 102-1 and 102-2, the roles of these devices is reversed for data streamed from the device 102-2 to the device 102-1 such that the device 102-2 serves as the data source device and the device 102-1 serves as the data sink device for this streamed data. As such, it will be appreciated that “source” and “sink” are relative to the directional flow of a corresponding data stream, rather than fixed references to particular devices in the system 100.

The network infrastructure 104 includes those components of the wireless communications system 100 that operate to convey streamed data from the data source device 102-1 to the data sink device 102-2. Such components include, for example, a source-facing infrastructure component 108-1 in wireless or wired communication with the data source device 102-1, a sink-facing infrastructure component 108-2 in wireless or wired communication with the data sink device 102-2, and the networks, servers, and other components that facilitate communications between the infrastructure components 108-1 and 108-2. These intermediary infrastructure components can include, for example a core network 1 (CN1) 110-1 associated with the source-facing infrastructure component 108-1, a core network 2 (CN2) 110-2 associated with the sink-facing infrastructure component 108-2, and one or more non-core networks 112 that connect the CN1 110-1 and the CN2 110-2. The one or more non-core networks 112, in turn, may include, or be coupled to, one or more application servers or other infrastructure components that provide support for the service on which the data stream is based. Note that in instances where the source-facing infrastructure component 108-1 and the sink-facing infrastructure component 108-2 (collectively, the “device-facing infrastructure components 108”) are supported by the same network operator, the CN1 110-1 and the CN2 110-2 may be the same core network.

In the particular example of FIG. 1, the data source device 102-1 and the data sink devices 102-1 are UEs (e.g., a smartphone, tablet computer, notebook computer, desktop computer, networked system of a vehicle, etc.) or other non-infrastructure devices (e.g., a wireless relay) wirelessly connected to a cellular base station or other infrastructure component, the source-facing infrastructure component 108-1 is a cellular base station (BS), and the sink-facing infrastructure component 108-2 is a WLAN AP. As such, the data source device 102-1, the data sink device 102-2, the source-facing infrastructure component 108-1, and sink-facing infrastructure component 108-2 are also referred to herein as UE 102-1, UE 102-2, BS 108-1, and AP 108-2, respectively. The UE 102-1 and the BS 108-1 are connected using a cellular radio access technology (RAT), such as a Third Generation Partnership Project (3GPP) Fourth Generation Long Term Evolution (4G LTE) RAT or a 3GPP Fifth Generation New Radio (5G NR) RAT. The UE 102-2 and the AP 108-2 are connected using a WLAN RAT, such as an International Electrical and Electronics Engineers (IEEE) 802.11-based RAT (that is, a “WiFi” RAT). The BS 108-1 and the AP 108-2 in turn are connected via their respective core networks 110-1 and 110-2 via one or more of the non-core networks 112, such as via the Internet. For ease of illustration, various aspects of the present disclosure are described below with reference to this particular example implementation. However, the techniques described herein are not limited to this implementation, but instead may be employed in any of a variety of network configurations. For example, both device-facing infrastructure components may be cellular base stations, or both device-facing infrastructure components may be WLAN access points. Still further, one device may be connected via a wired network to its corresponding device-facing infrastructure component. For example, the data source device 102-1 could include a cloud-based video game server that is connected to the CN2 110-2 via the Internet and which remotely executes an instance of a video game application, with the resulting video content and audio content streamed to the data sink device 102-2 via the Internet, the CN2 110-2, and the AP 108-2. The wireless RAT used to connect one of the devices 102 to its corresponding device-facing infrastructure component also can include a RAT other than a cellular RAT or WLAN RAT, such as a Bluetooth™-based RAT or other wireless personal area network (WPAN) RAT.

Data streaming from a data source device to a data sink device in a conventional wireless communication system relies on a series of process blocks, such as source encoding (e.g., data compression), channel encoding, channel decoding, and destination decoding (e.g., data decompression), that are designed, tested, and implemented relatively separate from each other. This custom and independent design approach for each process results in high complexity and considerable lack of resilience to changes in situational parameters. Rather than take a handcrafted approach for each individual process, the wireless communications system 100 employs an end-to-end neural network scheme that provides for rapid development and deployment, flexibility, and QoE optimization. In at least one embodiment, the end-to-end transmission path between the data source device 102-1 generating a data stream and the data sink device 102-2 consuming the data stream implements a chain 116 of DNNs or other neural networks that spans the nodes of the end-to-end transmission path and which is trained to, in effect, provide processing equivalent to a conventional sequence of processes without having to be specifically designed and tested for that sequence of processes.

To illustrate, a transmitter neural network 120 at the data source device 102-1 can be trained to receive a sequence of data blocks of a data stream from a data source module 122 and, for each input data block, generate a resulting output that represents an equivalent of a data encoded and channel encoded version of the data block. Conversely, a receiver neural network 124 of the data sink device 102-2 can be trained to receive a sequence of input signals, each representing a data encoded and channel encoded data block of the data stream and generate a recovered channel decoded and destination decoded version of the corresponding data block and provide it to a data sink module 126 that consumes or otherwise processes the data block. That is, the transmit neural network 120 of the data source device 102-1, through joint training, can be configured to provide the equivalent of a conventional data encoding process followed by a conventional channel encoding process in preparation for RF transmission. Meanwhile, the receiver neural network 124 of the data sink device 102-2, through joint training, can be configured to provide the equivalent of a conventional channel decoding process followed by a data decoding process in order to generate the recovered data block. In a similar manner, receiver/transmitter neural networks of some or all of the infrastructure components of the network infrastructure 104 between the data source device 102-1 and data sink device 102-2 can be trained to receive and decode (including demodulate) incoming RF signals for further processing by the wireless infrastructure or to encode (including modulate) data from the stream for transmission further along the transmission path. For example, the BS 108-1 can include an RX neural network 128 to channel decode and destination decode the RF signaling received from the data source device 102-1 and provide the resulting output for transmission to the CN1 110-1, which likewise may employ one or more neural networks 130 to process the signaling representative of the streamed content for transmission to the CN2 110-2. The CN2 110-2 then may employ one or more neural networks 132 to further process this signaling for transmission to the AP 110-2. The AP 110-2, in turn, may employ a TX neural network 134 to provide an output that is the equivalent of a source encoded and channel encoded representation of the information received from the CN2 110-2 for RF transmission to the data sink device 102-2, which, as noted above, can employ its sink RX neural network 124 to process this signaling to recover a representation of the original data for provision to the data sink module 126. The result is an end-to-end chain of neural networks that have been jointly trained to provide efficient processing of data blocks of the data stream at various nodes in the transmission path without requiring extensive design, test, and implementation of handcrafted processes at each node.

In at least one embodiment, the network infrastructure 104 includes a managing infrastructure component 136 (or “managing component 136” for purposes of brevity) that serves to manage the overall operation of the end-to-end chain 116, including one or more of overseeing the joint training of the neural networks of the end-to-end chain 116, managing the selection of a particular neural network architecture configuration for one or more of the nodes of the end-to-end chain 116, receiving and processing capability updates for purposes of neural network configuration selection, receiving and processing feedback for purposes of neural network training or selection, and the like. The managing component 136 can include a server or other networked component of one of the CNs 110, a server or other component connected to the non-core network 112, and the like. For example, in instances where both device-facing infrastructure components 108 are coupled to the same single core network and thus the end-to-end chain 116 is subject to control by a single network operator, the managing component 136 could be implemented at one of the device-facing infrastructure components or a server of the shared core network. In other instances where the transmission path spans multiple core networks and thus multiple network operators, the managing component 136 can include, for example, a third-party server or other intermediary component located on a non-core network 112. Still further, the functionality ascribed herein to the managing component 136 may be distributed across multiple infrastructure components, such as between servers of different core networks 110, between a server of a core network 110 and a corresponding device-facing infrastructure component 108, and the like.

As described below in more detail, the managing component 136 may elect a particular neural network architecture to be employed at a particular position in the end-to-end neural network chain 116 based at least in part on the present capabilities of the component implementing the corresponding neural network, the present capabilities of other components in the transmission chain, or a combination thereof. These capabilities can include, for example, sensor capabilities, processing resource capabilities, battery/power capabilities, RF antenna capabilities, as well as the data generation capabilities of the source of the data stream (e.g., image resolution capabilities) or the data consumption capabilities of the consumer of the data stream (e.g., display resolution of a display component used to display the image content of a video stream), including the capabilities of one or more accessories of one or both of the data source device or data sink device. To this end, in some embodiments, the managing component 136 can manage the joint training of different combinations of neural network architectural configurations for different capability combinations. The managing component 136 then can obtain capability information from the data source device, the data sink device, and one or more intermediary nodes in the transmission path. From this capability information, the managing component 136 selects neural network architectural configurations for each component in the path based at least in part on the corresponding indicated capabilities, and thus provides for overall configuration of the end-to-end neural network chain 116 between the data source device 102-1 and the data sink device 102-2 in a manner that better suits the capabilities of nodes in the chain.

Further, in some embodiments, the data sink device 102-2 provides feedback to the managing component 136 in the form of objective quality metrics (that is, objective feedback that is independent of user input) or user-supplied subjective quality metrics (that is, subjective feedback based on user input) as the data stream is transmitted and processed, and the managing component utilizes 136 this feedback to further refine or modify the neural network architectural configuration of one or more neural networks in the end-to-end neural network chain 116. This can include, for example, the managing component 136 refining the weights used in the present architectural configuration or determining a new, separate DNN architecture to employ. Similarly, when a node in the end-to-end chain 116 experiences a change in capability, such as a reduction in available battery power, addition or removal of an accessory, or a change in signal-to-noise ratio at an RF antenna interface, the managing component 136 can switch the neural network architecture configuration employed at that node to a new or modified configuration to adapt to the changed capabilities.

The use of a managed, jointly-trained end-to-end chain of neural networks between the data source device and data sink device facilitates a holistic data streaming process based on trained coordination, rather than independently-designed process blocks that may not have been specifically designed for optimal compatibility, Not only does this provide for improved flexibility, but in some circumstances can provide for more rapid processing at each node, and thus decrease the latency in transmitting each data block of the data stream compared to a modular design approach. This decreased latency is particularly relevant to improving the quality of experience (QoE) for real-time data streams, such as the audio stream of a voice call between two UEs, the audio stream or video stream of a video call between two UEs, or the rendered video stream generated by a cloud-based video gaming server and streamed for display at a UE.

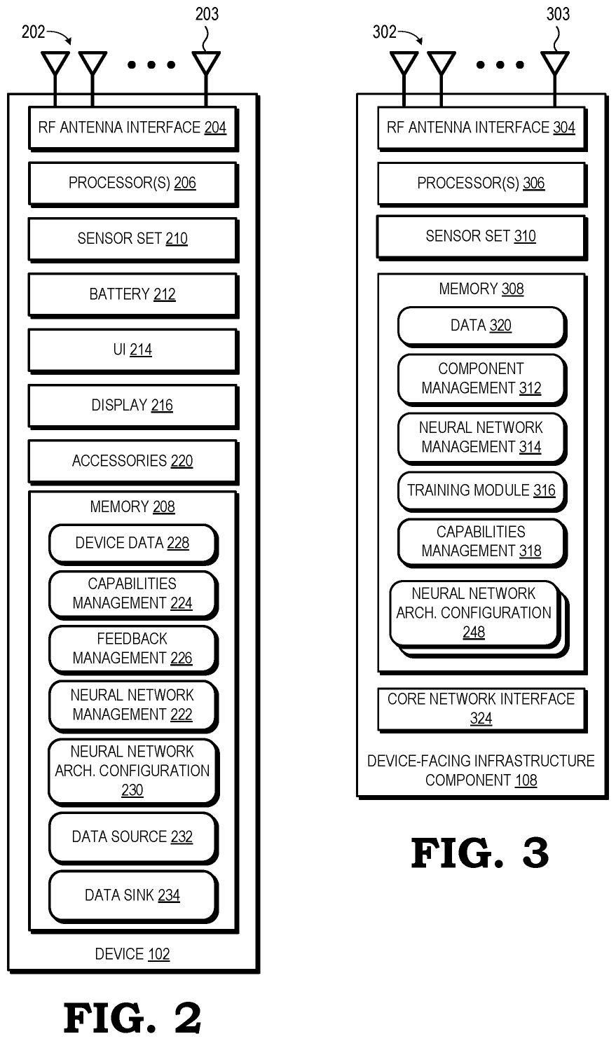

FIG. 2 illustrates an example hardware configuration for either of the data source device 102-1 and the data sink device 102-2 (collectively or individually, “device 102”) in accordance with some embodiments. Note that the depicted hardware configuration represents the processing components and communication components most directly related to the neural network-based processes described herein and omit certain components well-understood to be frequently implemented in such electronic devices.

In the depicted configuration, the device 102 includes one or more antenna arrays 202, with each antenna array 202 having one or more antennas 203, and further includes an RF antenna interface 204, one or more processors 206, and one or more non-transitory computer-readable media 208. The RF antenna interface 204 operates, in effect, as a physical (PHY) transceiver interface to conduct and process signaling between the one or more processors 206 and the antenna array 202 so as to facilitate various types of wireless communication. The antennas 203 can include an array of multiple antennas that are configured similar to or different from each other and can be tuned to one or more frequency bands associated with a corresponding RAT. The one or more processors 206 can include, for example, one or more central processing units (CPUs), graphics processing units (GPUs), an artificial intelligence (AI) accelerator or other application-specific integrated circuits (ASIC), and the like. To illustrate, the processors 206 can include an application processor (AP) utilized by the device 102 to execute an operating system and various user-level software applications, as well as one or more processors utilized by modems or a baseband processor of the RF antenna interface 204. The computer-readable media 208 can include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the computer-readable media 208 is referred to herein as “memory 208” in view of frequent use of system memory or other memory to store data and instructions for execution by the processor 206, but it will be understood that reference to “memory 208” shall apply equally to other types of storage media unless otherwise noted.

In at least one embodiment, the device 102 further includes a plurality of sensors, referred to herein as sensor set 210, at least some of which are utilized in the neural-network-based schemes described herein. Generally, the sensors of sensor set 210 include those sensors that sense some aspect of the environment of the device 102 or the use of the device by a user which have the potential to sense a parameter that has at least some impact on, or is a reflection of, an RF propagation path of, or RF transmission/reception performance by, the device 102 relative to the corresponding device-facing infrastructure component 108. The sensors of sensor set 210 can include one or more sensors for object detection, such as radar sensors, lidar sensors, imaging sensors, structured-light-based depth sensors, and the like. The sensor set 210 also can include one or more sensors for determining a position or pose of the device 102, such as satellite positioning sensors such as GPS sensors, Global Navigation Satellite System (GNSS) sensors, internal measurement unit (IMU) sensors, visual odometry sensors, gyroscopes, tilt sensors or other inclinometers, ultrawideband (UWB)-based sensors, and the like. Other examples of types of sensors of sensor set 210 can include imaging sensors, such as cameras for image capture by a user, cameras for facial detection, cameras for stereoscopy or visual odometry, light sensors for detection of objects in proximity to a feature of the device, and the like.

The device 102 further can include one or more batteries 212 or other portable power sources, as well as one or more user interface (UI) components 214, such as touch screens, user-manipulable input/output devices (e.g., “buttons” or keyboards), or other touch/contact sensors, microphones or other voice sensors for capturing audio content, image sensors for capturing video content, thermal sensors (such as for detecting proximity to a user), and the like. Further, the device 102 also can include a display panel 216 for displaying video content and one or more speakers for outputting audio content. Further, in at least one embodiment, the device 102 can include one or more wired or wireless accessories 220 associated with generation of content to be streamed or for the consumption of content received in a stream. For example, the device 102, when operating as the data sink device 102-2, can include a wired or wireless audio headset accessory used to output the audio content of a received audio stream, a wired or wireless head-mounted display (HMD) used to display the video content of a received video stream, and the like. Conversely, the device 102, when operating as the data source device 102-1, can include accessories in the form of, for example, a wired or wireless microphone used to capture audio content, a wired or wireless video camera for capturing video content, a printer or other peripheral device that is controlled based on the data stream, and the like.

The one or more memories 208 of the device 102 are used to store one or more sets of executable software instructions and associated data that manipulate the one or more processors 206 and other components of the device 102 to perform the various functions described herein and attributed to the device 102. The sets of executable software instructions include, for example, an operating system (OS) and various drivers (not shown), and various software applications. The sets of executable software instructions further include a neural network management module 222, a capabilities management module 224, and a feedback management module 226. The neural network management module 222 implements one or more neural networks for the device 102, as described in detail below. The capabilities management module 224 monitors the device 102 for changes in the capabilities of the device 102, including changes in RF and processing capabilities, changes in accessory availability or capability, and the like, and manages the reporting of such capabilities, and changes in the capabilities, to the managing component 136. When the device 102 is operating as the data sink device 102-2, the feedback management module 226 operates to obtain one or both of objective feedback regarding the processing of a received data stream (such as one or more standardized quality of service (QOS) or QoE metrics) or subjective feedback from a user regarding the processing and/or utilization of the received data stream and provides a representation of this feedback to the managing component 136. These operations are described in greater detail below.

To facilitate the operations of the device 102 as described herein, the one or more memories 208 of the device 102 further can store data associated with these operations. This data can include, for example, device data 228 and one or more neural network architecture configurations 230. The device data 228 represents, for example, user data, multimedia data, beamforming codebooks, software application configuration information, and the like. The device data 228 further can include capability information for the device 102, such as sensor capability information regarding the one or more sensors of the sensor set 210, including the presence or absence of a particular sensor or sensor type, and, for those sensors present, one or more representations of their corresponding capabilities, such as range and resolution for lidar or radar sensors, image resolution and color depth for imaging cameras, and the like. The capability information further can include information regarding, for example, the capabilities of the one or more accessories 220 associated with the device 102, such as screen resolution, color gamut, or frame rate for a display accessory, the frequency response, sample rate, and the number of channels for an audio headset accessory, and the like.

The one or more neural network architecture configurations 230 include one or more data structures containing data and other information representative of a corresponding architecture and/or parameter configurations used by the neural network management module 222 to form a corresponding neural network of the device 102. The information included in a neural network architectural configuration 230 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 230 includes any combination of NN formation configuration elements (e.g., architecture and/or parameter configurations) that can be used to create a NN formation configuration (e.g., a combination of one or more NN formation configuration elements) that defines and/or forms a DNN.

Further, the device 102 includes the data source module 122 when operating as the data source device 102-1, the data sink module 126 when operating as the data sink device 102-2, or both when operating as both a data source device for an outgoing data stream and as a data sink device for an incoming data stream. One or both of the data source module 122 and the data sink module 126 can be implemented as software applications, such as a data source application 232 or a data sink application 234, respectively, stored in the one or more memories 208 of the device 102. In other embodiments, one or both of the data source module 122 and the data sink module 126 are implemented as hardware modules, such as in ASICS or a programmable logic device (PLD), while in still other embodiments, one or both of the modules 122 and 126 are implemented as a combination of one or more hardware modules and one or more software applications.

FIG. 3 illustrates an example hardware configuration for a device-facing infrastructure component 108, such as the source-facing infrastructure component 108-1 or the sink-facing infrastructure component 108-2, in accordance with some embodiments. Note that the depicted hardware configuration represents the processing components and communication components most directly related to the neural network-based processes described herein and omit certain components well-understood to be frequently implemented in such electronic devices. Further, it is noted that although FIG. 3 illustrates the device-facing infrastructure component 108 as a single network node (e.g., a 5G NR Node B or a WiFi AP), the functionality, and thus the hardware components, of the device-facing infrastructure component 108 instead may be distributed across multiple infrastructure components or nodes and may be distributed in a manner to perform the functions described herein.

As with the device 102, the device-facing infrastructure component 108 includes at least one array 302 of one or more antennas 303, an RF antenna interface 304, as well as one or more processors 306 and one or more non-transitory computer-readable storage media 308 (as with the memory 208 of the device 102, the computer-readable medium 308 is referred to herein as a “memory 308” for brevity). The device-facing infrastructure component 108 further includes a sensor set 310 having one or more sensors that provide sensor data that may be used for the NN-based sensor-and-transceiver fusion schemes described herein. As with the sensor set 210 of the device 102, the sensor set 310 of the device-facing infrastructure component 108 can include, for example, object-detection sensors and imaging sensors, and in instances in which the device-facing infrastructure component 108 is mobile (such as when implemented in a vehicle or a drone), one or more sensors for detecting position or pose. These components operate in a similar manner as described above with reference to corresponding components of the device 102.

The one or more memories 308 of the device-facing infrastructure component 108 store one or more sets of executable software instructions and associated data that manipulate the one or more processors 306 and other components of the device-facing infrastructure component 108 to perform the various functions described herein and attributed to the device-facing infrastructure component 108. The sets of executable software instructions include, for example, an operating system (OS) and various drivers (not shown), various software applications (not shown), a component management module 312, and a neural network management module 314. The component management module 312 configures the RF antenna interface 304 for communication with the device 102, as well as communication with a core network, such as one of the core networks 110. The neural network management module 314 implements one or more neural networks for the device-facing infrastructure component 108, such as the neural networks employed in the TX and RX processing paths as described herein.

In at least one embodiment, the software stored in the memory 308 further includes one or more of a training module 316 and a capabilities management module 318. The training module 316 operates to train one or more neural networks implemented at the device-facing infrastructure component 108 or the device 102 using one or more sets of input data. This training can be performed for various purposes, such as processing communications transmitted over a wireless communication system. The training can include training neural networks while offline (that is, while not actively engaged in processing the communications) and/or online (that is, while actively engaged in processing the communications). Moreover, the training may be individual or separate, such that each neural network is individually trained on its own data set without the result being communicated to, or otherwise influencing, the DNN training at the opposite end of the transmission path, or the training may be joint training, such that the neural networks in a data stream transmission path are jointly trained on the same, or complementary, data sets. As with the capabilities management module 224 of the device 102, the capabilities management module 318 of the device-facing infrastructure component 108 monitors the infrastructure component 108 for changes in capabilities, such as changes in RF and processing capabilities, and manages the reporting of such capabilities, and changes in the capabilities, to the managing component 136.

The data stored in the one or more memories 308 of the device-facing infrastructure component 108 includes, for example, component data 320 and one or more neural network architecture configurations 322. The component data 320 represents, for example, network scheduling data, radio resource management data, beamforming codebooks, software application configuration information, and the like. The component data 320 further can include capability information for the infrastructure component 108, such as sensor capability information regarding the one or more sensors of the sensor set 310, including the presence or absence of a particular sensor or sensor type, and, for those sensors present, one or more representations of their corresponding capabilities. The one or more neural network architecture configurations 322 include one or more data structures containing data and other information representative of a corresponding architecture and/or parameter configurations used by the neural network management module 314 to form a corresponding neural network of the device-facing infrastructure component 108. Similar to the neural network architectural configuration 230 of the device 102, the information included in a neural network architectural configuration 322 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 322 includes any combination of NN formation configuration elements that can be used to create a NN formation configuration that defines and/or forms a DNN or other neural network. In some embodiments, the device-facing infrastructure component 108 further includes a core network interface 324 that the component management module 312 configures to exchange user-plane, control-plane, and other information with core network functions and/or entities.

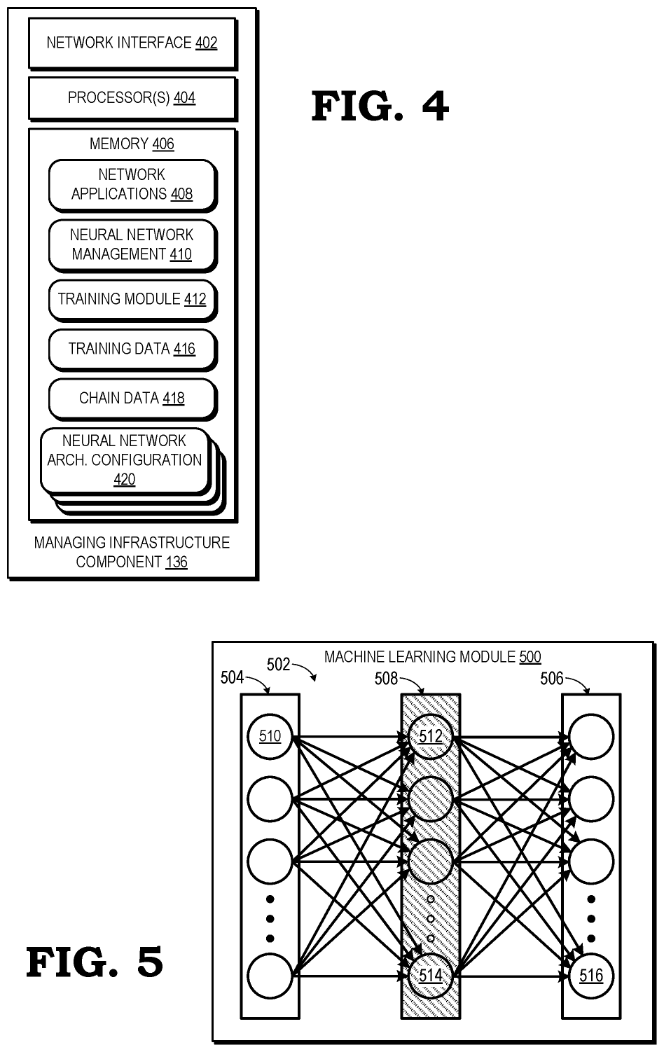

FIG. 4 illustrates an example hardware configuration for the managing component 136 in accordance with some embodiments. Note that the depicted hardware configuration represents the processing components and communication components most directly related to the neural network-based processes described herein and omit certain components well-understood to be frequently implemented in such electronic devices. Further, although the hardware configuration is depicted as being located at a single component, the functionality, and thus the hardware components, of the managing component 136 instead may be distributed across multiple infrastructure components or nodes and may be distributed in a manner to perform the functions described herein.

As noted above, the managing component 136 can be implemented at any of a variety of components, or combination of components, within the network infrastructure 104, such as at a base station, access point, or other device-facing infrastructure component 108, at a server or other component of a core network 110, at an application server or other component located in a non-core network 112, such as a private network or on a network of the Internet, and the like. For ease of illustration, the managing component 136 is described herein with reference to an example implementation as a server or other component in one of the core networks 110.

As shown, the managing component 136 includes one or more network interfaces 402 (e.g., an Ethernet interface) to couple to one or more networks of the system 100, one or more processors 404 coupled to the one or more network interfaces 402, and one or more non-transitory computer-readable storage media 406 (referred to herein as a “memory 406” for brevity) coupled to the one or more processors 404. The one or more memories 406 store one or more sets of executable software instructions and associated data that manipulate the one or more processors 404 and other components of the managing component 136 to perform the various functions described herein and attributed to the managing component 136. The sets of executable software instructions include, for example, an OS and various drivers (not shown) and one or more network applications that support the data stream transmitted from the data source device 102-1 to the data sink device 102-2. For example, in Voice-over-Internet-Protocol (VOIP) implementation in which audio content captured at the data source device 102-1 is transmitted to the data sink device 102-2 as a corresponding data stream, the supporting software applications can include, for example, one or more IP multimedia subsystem (IMS) applications configured to facilitate the initiation, maintenance, and teardown of the corresponding VoIP connection.

The software stored in the one or more memories 406 further can include a training module 412 that operates to manage the joint training of the neural networks available to be employed throughout the neural network chain 116 using one or more sets of training data 416. The training can include training neural networks while offline (that is, while not actively engaged in processing the communications) and/or online (that is, while actively engaged in processing the communications). Moreover, the training may be individual or separate, such that each neural network is individually trained on its own training data set without the result being communicated to, or otherwise influencing, the DNN training at the opposite end of the transmission path, or the training may be joint training, such that the neural networks in a data stream transmission path are jointly trained on the same, or complementary, data sets. Other data stored in the one or more memories 406 includes, for example, chain data 418 and one or more neural network architecture configurations 420. The chain data 418 represents, for example, present capability information for some or all of the infrastructure components 108, core networks 110, and devices 102 in the transmission path of a supported data stream, an identifier of the neural network architecture configuration implemented at each of these nodes or indications of the parameters of the neural network architecture configurations implemented at the nodes, and feedback information received from the data sink device 102-2 as streaming of the data progresses.

In implementations in which the managing component 136 operates in one of the core networks 110 and thus is in the transmission path of the data stream, the memory 406 can utilize the neural network management module 410 to implement one or more neural networks for furthering transmission of the data stream, such as the neural networks employed one or both of the TX and RX processing paths as described herein. As with the neural network architecture configurations of the device 102 and the device-facing infrastructure component 108, the one or more neural network architecture configurations 420 include one or more data structures containing data and other information representative of a corresponding architecture and/or parameter configurations used by the neural network manager 410 to form a corresponding neural network of the managing component 136. This information can include, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 420 includes any combination of NN formation configuration elements that can be used to create a NN formation configuration that defines and/or forms a DNN or other neural network.

FIG. 5 illustrates an example machine learning (ML) module 500 for implementing a neural network in accordance with some embodiments. As described herein, one or more of the device 102, the device-facing infrastructure component 108, and the core network 110 implements one or more DNNs or other neural networks in one or both of the TX processing paths or RX processing paths for processing incoming and outgoing wireless communications. The ML module 500 therefore illustrates an example module for implementing one or more of these neural networks.

In the depicted example, the ML module 500 implements at least one deep neural network (DNN) 502 with groups of connected nodes (e.g., neurons and/or perceptrons) that are organized into three or more layers. The nodes between layers are configurable in a variety of ways, such as a partially-connected configuration where a first subset of nodes in a first layer are connected with a second subset of nodes in a second layer, a fully-connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 502, the ML module 500 performs a variety of different types of analysis, including single linear regression, multiple linear regression, logistic regression, step-wise regression, binary classification, multiclass classification, multivariate adaptive regression splines, locally estimated scatterplot smoothing, and so forth.

In some implementations, the ML module 500 adaptively learns based on supervised learning. In supervised learning, the ML module 500 receives various types of input data as training data. The ML module 500 processes the training data to learn how to map the input to a desired output. As one example, the ML module 500 receives digital samples of a signal as input data and learns how to map the signal samples to binary data that reflects information embedded within the signal. As another example, the ML module 500 receives binary data as input data and learns how to map the binary data to digital samples of a signal with the binary data embedded within the signal. Still further, as another example and as described in greater detail below, when used in a TX mode, the ML module 500 receives an outgoing information block and learns both how to generate an output that, in effect, represents a data encoded (e.g., compressed) and channel encoded represented in the information block so as to form an output suitable for wireless transmission by an RF antenna interface. Conversely, the ML module 500, when implemented in an RX mode, can be trained to receive an input that represents, in effect, a data encoded and channel encoded representation of an information block, and process the input to generate an output that is, in effect, a data decoded and channel decoded representation of the input, and thus represents a recovered representation of the data of the information. As described further below, the training in either or both of the TX mode or the RX mode further can include training using sensor data as input, capability information as input, accessory information as input, and the like.

During a training procedure, the ML module 500 uses labeled or known data as an input to the DNN 502. The DNN 502 analyzes the input using the nodes and generates a corresponding output. The ML module 500 compares the corresponding output to truth data and adapts the algorithms implemented by the nodes to improve the accuracy of the output data. Afterward, the DNN 502 applies the adapted algorithms to unlabeled input data to generate corresponding output data. The ML module 500 uses one or both of statistical analysis and adaptive learning to map an input to an output. For instance, the ML module 500 uses characteristics learned from training data to correlate an unknown input to an output that is statistically likely within a threshold range or value. This allows the ML module 500 to receive complex input and identify a corresponding output. As noted, some implementations train the ML module 500 on characteristics of communications transmitted over a wireless communication system (e.g., time/frequency interleaving, time/frequency deinterleaving, convolutional encoding, convolutional decoding, power levels, channel equalization, inter-symbol interference, quadrature amplitude modulation/demodulation, frequency-division multiplexing/de-multiplexing, transmission channel characteristics) concurrent with characteristics of data encoding/decoding schemes employed in such systems. This allows the trained ML module 500 to receive samples of a signal as an input and recover information from the signal, such as the binary data embedded in the signal.

In the depicted example, the DNN 502 includes an input layer 504, an output layer 506, and one or more hidden layers 508 positioned between the input layer 504 and the output layer 506. Each layer has an arbitrary number of nodes, where the number of nodes between layers can be the same or different. That is, the input layer 504 can have the same number and/or a different number of nodes as output layer 506, the output layer 506 can have the same number and/or a different number of nodes than the one or more hidden layer 508, and so forth.

Node 510 corresponds to one of several nodes included in input layer 504, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 510 can determine whether to pass the processed input data to one or both of node 512 and node 514 of hidden layer 508. Alternatively or additionally, node 510 passes the processed input data to nodes based upon a layer connection architecture. This process can repeat throughout multiple layers until the DNN 502 generates an output using the nodes (e.g., node 516) of output layer 506.

A neural network can also employ a variety of architectures that determine what nodes within the neural network are connected, how data is advanced and/or retained in the neural network, what weights and coefficients are used to process the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 502 or other neural network processes input data.

A neural network architecture configuration of a neural network can be characterized by various architecture and/or parameter configurations. To illustrate, consider an example in which the DNN 502 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer, and use the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 506) to every node in a second layer (e.g., hidden layer 508), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that can be applied to a DNN that influences how the DNN processes input data to generate output data.

In some embodiments, the configuration of the ML module 500 is further based on a present operating environment. To illustrate, consider an ML module trained to generate binary data from digital samples of a signal. An RF signal propagation environment oftentimes modifies the characteristics of a signal traveling through the physical environment. RF signal propagation environments oftentimes change, which impacts how the environment modifies the signal. A first RF signal propagation environment, for instance, modifies a signal in a first manner, while a second RF signal propagation environment modifies the signal in a different manner than the first. These differences impact the accuracy of the output results generated by the ML module 500. For instance, the DNN 502 configured to process communications transmitted in the first RF signal propagation environment may generate errors or otherwise limit performance when processing communications transmitted in the second RF signal propagation environment. Certain sensors of the sensor set of the component implementing the DNN 502 may provide sensor data that represents one or more aspects of the present RF signal propagation environment. Examples noted above can include lidar, radar, or other object-detecting sensors to determine the presence or absence of interfering objects within a LOS propagation path, UI sensors to determine the presence and/or position of a user's body relative to the component, and the like. However, it will be appreciated that the particular sensor capabilities available may depend on the particular device 102 or the particular device-facing infrastructure component 108. For example, the BS 108-1 may have lidar or radar capability, and thus the ability to detect objects in proximity, while the WiFi AP 108-2 may lack lidar and radar capabilities. As another example, a smartphone (one embodiment of the device 102) may have a light sensor that may be used to sense whether the smartphone is in a user's pocket or bag, while a notebook computer (another embodiment of the device 102) may lack this capability. As such, in some embodiments, the particular configuration implemented for the ML module 500 may depend at least in part on the particular sensor configuration of the device implementing the ML module 500.

The configuration of the ML module 500 also may be based on capabilities of the node implementing the ML module 500, of one or more nodes upstream or downstream of the node implementing the ML module 500, or a combination thereof. For example, in a video streaming implementation, a display panel implemented at the data sink device 102-2 may have any of a variety of different capability parameters, such as resolution, frame rate, color gamut, and the like, and thus the ML module 500 at each of the data source device 102-1 and the data sink device 102-2 may be separately trained for some or all of the variations in some or all of these capability parameters. As another example, the data source device 102-1 may be battery power limited, and thus the ML module 500 for both the data source device 102-1 and the data sink device 102-2 may be trained based on battery power as an input so as to facilitate, for example, the ML modules 500 at both ends to employ a data coding/channel coding (or channel modulation) scheme that is better suited to lower power consumption.

Accordingly, in some embodiments, the node implementing the ML module 500 generates and stores different neural network architecture configurations for different combinations of capability parameters, RF environment parameters, and the like. For example, a device may have one or more neural network architectural configurations for use when an imaging camera is available for use at the device and the data sink device 102-2 utilizes a five-channel audio system, and a different set of one or more neural network architectural configurations for use when the imaging camera is unavailable at the device and the data sink device 102-2 utilizes a two-channel audio system.

To this end, the managing component 136 trains the ML modules 500 of the neural network chain 116 using any combination of the neural network management modules and training modules located at each node in the chain 116. The training can occur offline when no active communication exchanges are occurring, or online during active communication exchanges. For example, the managing component 136 can mathematically generate training data, access files that store the training data, obtain real-world communications data, etc. The managing component 136 then extracts and stores the various learned neural network architecture configurations for subsequent use. Some implementations store input characteristics with each neural network architecture configuration, whereby the input characteristics describe various properties of one or both of the RF signal propagation environment and capability configuration corresponding to the respective neural network architecture configurations. In implementations, a neural network manager selects a neural network architecture configuration by matching a present RF signal propagation environment and present operational environment to the input characteristics, with the present operating environment including indications of capabilities of one or more nodes along the chain 116, such as sensor capabilities, RF capabilities, streaming accessory capabilities, processing capabilities, and the like.

As noted, network devices that are in wireless communication, such as the device 102 and the corresponding device-facing infrastructure component 108, can be configured to process wireless communication exchanges using one or more DNNs at each networked device, where each DNN replaces one or more functions conventionally implemented by one or more hard-coded or fixed-design blocks (e.g., uplink processing, downlink processing, uplink encoding processing, downlink decoding processing, etc.). Moreover, each DNN can further incorporate present sensor data from one or more sensors of a sensor set of the networked device and or capability data from some or all of the nodes along the chain 116 to, in effect, modify or otherwise adapt its operation to account for the present operational environment.

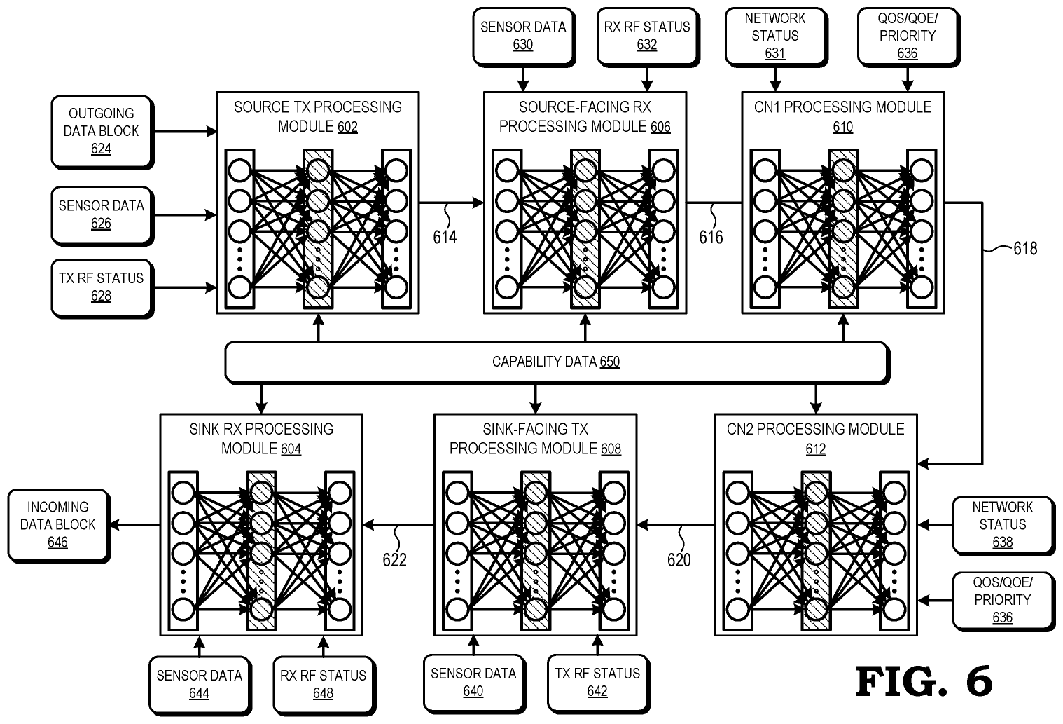

To this end, FIG. 6 illustrates an example operating environment 600 for DNN implementation in the end-to-end neural network chain 116 between the data source device 102-1 and the data sink device 102-2. In the depicted example, the neural network management module 222 of the data source device 102-1 implements a source transmitter (TX) processing module 602, while the neural network management module 222 of the data sink device 102-2 implements a sink receiver (RX) processing module 604. In the chain of neural networks between source and sink, the source-facing infrastructure component 108-1 implements a source-facing RX processing module 606 and the sink-facing infrastructure component 108-2 implements a sink-facing TX processing module 604. In some embodiments, the transmission path from the source-facing infrastructure component 108-1 to the sink-facing infrastructure component 108-2 may utilize conventional processing and signaling techniques, and thus not require corresponding ML processing modules. However, in other embodiments, one or more of the transmission links between device-facing infrastructure component 108 and the corresponding CN 110, or between CNs 110, may utilize ML processing modules at the TX side and RX side of the transmission link. As such, the source-facing infrastructure component 108-1 further may implement a TX processing module (not shown for ease of illustration) for transmissions to the CN1 110-1 and the CN1 110-1 may implement an RX processing module for receiving transmissions from the TX processing module of the source-facing infrastructure component 108-1 and a TX processing module for corresponding transmissions to the CN2 110-2 via the one or more networks 112 (one or both of these processing modules being collectively represented by CN1 processing module 610 in FIG. 6). Similarly, the CN2 110-2 may implement an RX processing module for receiving transmissions from the CN1 110-1 and a TX processing module for transmissions to the sink-facing infrastructure component 108-2 (one or both of these processing modules being collectively represented by CN1 processing module 612) in FIG. 6, and the sink-facing infrastructure component 108-2 in turn can implement an RX processing module (not shown for ease of illustration) to receive and process transmissions from the CN2 110-2. In at least one embodiment, each of these processing modules implements one or more DNNs via the implementation of a corresponding ML module, such as described above with reference to the one or more DNNs 502 of the ML module 500 of FIG. 5.

The source TX processing module 602 of the data source device 102-1 and the source-facing RX processing module 606 of the source-facing infrastructure component 108-1 interoperate to support a wireless communication path 614 between the data source device 102-1 and the source-facing infrastructure component 108-1. Corresponding processing modules and/or conventional communication components of one or more of the source-facing infrastructure component 108-1, CN1 110-1, CN2 110-2, and the sink-facing infrastructure component 108-2 likewise interoperate to support a series of communication paths between the source-facing infrastructure component 108-1 and the sink-facing infrastructure component 108-2. The sink-facing TX processing module 608 of the sink-facing infrastructure component 108-2 and the sink RX processing module 604 of the data sink device 102-2 in turn interoperate to support a wireless communication path 622 between the sink-facing infrastructure component 108-2 and the data sink device 102-2. Thus, the sequence of communication paths 614, 616, 618, 620, and 622 represents the transmission path for communicating signals representative of data of a data stream from the data source module 122 to the data sink module 126.

The one or more DNNs of the source TX processing module 602 are trained to receive an outgoing data block 624 of a data stream generated by the data source module 122 as an input, as well as other inputs such as sensor data 626 from the sensor set 210 and transmitter RF status information 628 representing present parameters for the transmit-side of the RF antenna interface 204, and from these inputs generate a corresponding output for transmission as RF signals via an RF analog stage of the RF antenna interface 204 of the data source device 102-1. In particular, in some embodiments the one or more DNNs of the source TX processing module 602 are trained to provide processing that, in effect, results in a data encoded (e.g., compressed) and channel-encoded (including modulation and error code or redudancy) representation of the data block 624 that is ready for digital-to-analog conversion and RF transmission. That is, rather than employ separate discrete processing blocks to implement a data encoding process followed by an initial RF encoding process, the TX processing module 602 is trained to concurrently provide the equivalent of such processes and based at least in part on other present data such as the sensor data 626 and the transmission RF status information 628, to generate a corresponding signal that is, in effect, source encoded and channel encoded and thus ready for RF transmission.

The output generated by the source TX processing module 602 is wirelessly transmitted by the data source device 102-1 and initially processed by the RF antenna interface 304 of the source-facing infrastructure component 108-1. The one or more DNNs of the source-facing RX processing module 606 are trained to receive the resulting output of the RF antenna interface 304 as an input, along with one or more other inputs, such as sensor data 630 from the sensor set 310 and receiver RF status information 632 representing present parameters for the receive-side of the RF antenna interface 304, and the like, and from these inputs, generate a corresponding output for transmission to the CN1 110-1. The processing performed by the source-facing RX processing module 606 can include, for example, channel decoding of the input signal to generate a digital representation of a data encoded version of the outgoing data block 624. Still further, in other embodiments, the processing could include decoding of the data itself to generate a decoded representation of the data block 624, which can then be subsequently re-encoded for downstream transmission.

The resulting output of the source-facing RX processing module 606 then may be transmitted from the source-facing infrastructure component 108-1 to the sink-facing infrastructure device 108-2 via the CN1 110-1 and the CN2 110-2 and the corresponding communication paths 616, 618, and 620. In some embodiments, these paths are implemented via conventional transmission techniques, such as the packetization of the output into IP-based packets and transmission of the resulting IP-based packets using conventional IP techniques. In other embodiments, some or all of these paths are supported by a TX processing module employing one or more DNNs at the transmit side of the communication path and a corresponding RX processing module employing one or more DNNs at the receive side of the communication path. For example, the CN1 processing module 610 of the CN1 110-1 can represent a TX processing module that has one or more DNNs that are trained to receive a representation of a signal representing the data block 624 received at the CN1 110-2 as an input, along with other inputs such as network status information 634 for the network 112 and QoS, QoE, or other priority information 636 indicating a prioritization, QoS, or QoE parameter for the data stream, and from these inputs generate a corresponding output that is then packetized and transmitted to the CN2 110-2 via the network 112, whereupon an RX processing module implemented as the CN2 processing module 612 at the CN2 110-2 includes one or more DNNs to receive this output as an input, along with other inputs such as network status information 638 for the network 112 and the priority information 636, and from this generate an output that can be further transmitted down the chain of ML processing modules.

At the sink-facing infrastructure component 108-2, the one or more DNNs of the sink-facing TX processing module 608 are configured to receive the representation of the data block 624 received from the upstream node as an input, as well as one or more other inputs such as sensor data 640 from the sensor set 310 and transmitter RF status information 642 representing present parameters for the transmit-side of the RF antenna interface 304 of the infrastructure component 108-2, and the like, and from these inputs generate a corresponding output for transmission as RF signals via an RF analog stage of the RF antenna interface 304 of the sink-facing infrastructure component 108-2. In particular, in some embodiments the one or more DNNs of the sink-facing TX processing module 608 are trained to provide processing that, in effect, results in a channel-encoded (including modulation) representation of the data block 624 that is ready for digital-to-analog conversion and RF transmission. Still further, in some embodiments the one or more DNNs also are trained to concurrently provide, in effect, data coding of the representation of the data block 624, which may be the same form of data coding employed by the source TX processing module 602 or a different or supplemental form of data coding.

The output generated by the sink-facing TX processing module 608 is wirelessly transmitted by the sink-facing infrastructure component 108-2 and initially processed by the RF antenna interface 204 of the data sink device 102-2. The one or more DNNs of the sink RX processing module 604 are trained to receive the resulting output from the RF antenna interface 204 as an input, along with one or more other inputs, such as sensor data 644 from the sensor set 210 of the data sink device 102-2 or receiver RF status information 648 representing present parameters for the receive-side of the RF antenna interface 204, and from these inputs generate an incoming data block 646 that represents the original outgoing data block 624 generated at the data source device 102-1. In particular, the one or more DNNs are trained to provide a process that, in effect, provides for channel decoding (including demodulation) of the output from the analog-to-digital stage of the RF antenna interface 204 and destination decoding (e.g., data decompression) of the channel decoded result so as to obtain a channel decoded and data decoded representation of the original data of the data block 624. That is, rather than employ separate discrete processing blocks to implement a channel decoding process followed by a data decoding process, the sink RX processing module 604 is trained to concurrently provide the equivalent of such processes and based at least in part on other present data such as the sensor data 644 and the receiver RF status information 648, to generate as an output a recovered version of the outgoing data block 624. Depending on the implementation and training, this recovery process may be lossless, such that the recovered version is an exact duplicate of the original data. In other implementations, the DNNs along the chain may be trained to employ lossy processes for purposes of efficiency or reduced complexity, and thus the recovered version of the original data block represented by the incoming data block 646 may be a lossy version of the data of the outgoing data block 624. In either event, the incoming data block 646 then may be provided to the data sink module 126 for consumption or further processing.

Further, as described herein, in some embodiments the managing component 136 uses the present capabilities of one or more of the devices 102, the infrastructure components 108, the CNs 110, or other nodes in the transmission path as a basis for selecting the particular DNN architectural configuration to be employed by a given processing module at a corresponding node. For example, the resolution capability of the display panel of the data sink device 102-2 may drive the managing component 136 to select DNNs for the source TX processing module 602 and the sink RX processing module 604 that have data coding and decoding processes trained specifically for the corresponding resolution capability. However, in other embodiments, rather than, or in addition to, using present capabilities to select DNN architectural configurations, one or more of the DNNs along the transmit path can utilize capability information for one or more nodes (collectively identified in FIG. 6 as capability data 650) as an input that controls the operation of the DNN itself. For example, capability data supplied by the data source device 102-1 indicating that it has limited battery reserves remaining may be input to the source TX processing module 602, and thus may manifest in the DNN(s) of the source TX processing module 602 providing a less power-intensive form of data coding in generating the resulting output, while this same data input to the sink RX processing module 604 manifests in the DNN(s) of the sink RX processing module 604 providing a complementary data decoding process to recover the original data.

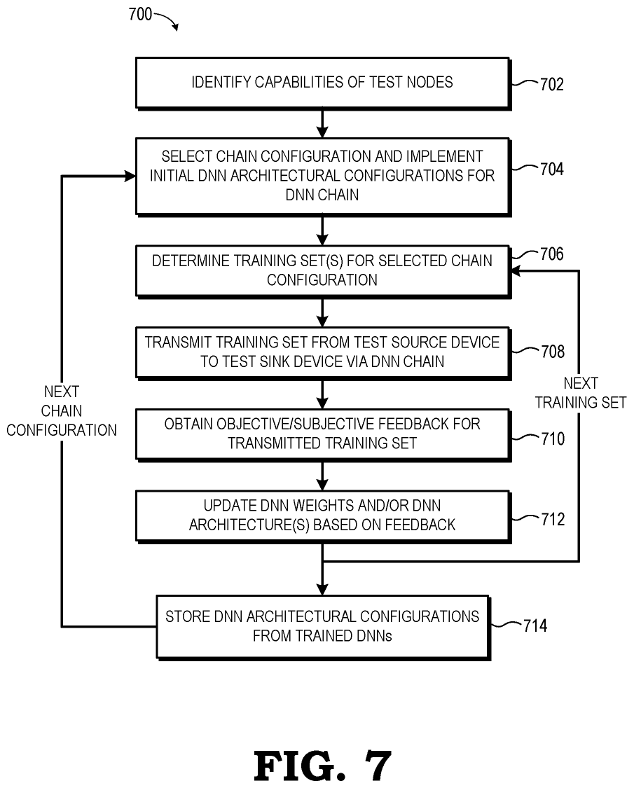

The implementation of jointly-trained DNNs or other neural networks for some or all of the nodes in the transmission path between the data source device 102-1 and the data sink device 102-2 provides flexibility in design and facilitates efficient updates relative to conventional per-block design and test approaches, while also allowing the various nodes in the transmission path to quickly adapt their processing of outgoing and incoming transmissions to present operational parameters. However, before the DNNs can be deployed and put into operation, they typically are trained or otherwise configured to provide suitable outputs for a given set of one or more inputs. To this end, FIG. 7 illustrates an example method 700 for developing one or more jointly-trained DNN architectural configurations as options for various nodes along the chain or transmission path between devices 102 for different operating environments in accordance with some embodiments. Note that the order of operations described with reference to FIG. 7 is for illustrative purposes only, and that a different order of operations may be performed, and further that one or more operations may be omitted or one or more additional operations included in the illustrated method. Further note that while FIG. 7 illustrates an offline training approach using one or more test nodes, a similar approach may be implemented for online training using one or more nodes that are in active operation.

As explained above, the operations of DNNs employed at some or all of the devices 102, the infrastructure components 108, the CNs 110, or other nodes in the DNN chain (e.g., chain 116, FIG. 1) of the transmission path for a data stream may be based on particular capabilities and present operational parameters of the node employing the corresponding DNN, of one or more upstream or downstream nodes, or a combination thereof. These capabilities and operational parameters can include, for example, the types of sensors used to sense the RF transmission environment of a node, the capabilities of such sensors, the power capacity of one or more nodes, the availability status of one or more accessories used to generate, consume, or otherwise process data from the data stream, and the like. Because the DNNs utilize such information to dictate their operations, it will be appreciated that in many instances the particular DNN configuration implemented at one of the nodes is based on particular capabilities and operational parameters presently employed at that node or at an upstream or downstream node; that is, the particular DNN configuration implemented is reflective of capability information and present operational parameters presently exhibited by one or more nodes in the transmission path of the data stream.

Accordingly, the method 700 initiates at block 702 with the determination of the anticipated capabilities (including anticipated operational parameters or parameter ranges) of one or more test nodes of a test transmission path, which would include a test data source device, a test data sink device, a source-facing infrastructure component, a sink-facing infrastructure component (which may be the same component as the source-facing infrastructure component), and the one or more core networks connecting the source-facing and sink-facing infrastructure components (if DNNs or other NNs are implemented in the core network(s) for transmission of a corresponding data stream). For the following, it is assumed that a training module 412 of the managing component 136 is managing the joint training, and thus the capability information for the nodes in the DNN chain is known to the training module 412 (e.g., via a database or other locally stored data structure storing this information). However, because the managing component 136 likely does not have a priori knowledge of the capabilities of any given UE, the test source and sink devices provide the managing component 136 with an indication of their respective capabilities, such as an indication of the types of sensors available at the test device, an indication of various parameters for these sensors (e.g., imaging resolution and picture data format for an imaging camera, satellite-positioning type and format for a satellite-based position sensor, etc.), accessories available at the device and applicable parameters (e.g., number of audio channels), and the like. For example, the test device can provide this indication of capabilities as part of the UECapabilityInformation Radio Resource Control (RRC) message typically provided by UEs in response to a UECapabilityEnquiry RRC message transmitted by a BS in accordance with at least the 4G LTE and 5G NR specifications. Alternatively, the test UE can provide the indication of sensor capabilities as a separate side-channel or control-channel communication. Further, in some embodiments, the capabilities of the test device may be stored in a local or remote database available to the managing component 136, and thus the managing component 136 can query this database based on some form of an identifier of the test device, such as an International Mobile Subscriber Identity (IMSI) value associated with the test device.

With the capabilities of the applicable nodes in the DNN chain identified, at block 704 the training module 412 selects a particular capability configuration for which to jointly train the DNNs of the DNN chain. In some embodiments, the training module 412 may attempt to train every permutation of the available capabilities. However, in implementations in which the nodes are likely to have a relatively large number and variety of capabilities, this effort may be impracticable. Accordingly, in other embodiments the training module 412 selects from only a limited, representative set of potential capability configurations. To illustrate, lidar information from different lidar modules manufactured by the same company may be relatively consistent, and thus if, for example, a source/sink device could implement any of a number of lidar sensors from that manufacturer, the training module 412 may choose to eliminate several lidar sensors from the sensor configurations being trained. As another example, while a data sink device could have a headset accessory with any of a variety of audio sample rate capabilities, the training module 412 may choose to eliminate all but a few of the most frequently used audio sample rate options. Still further, the capabilities of certain components, such as the core networks 110 may not be particularly relevant to effective training, and thus the training module 412 may ignore the reported capabilities of the test core networks in the DNN chain, or assume a single default or minimum set of capabilities for these particular nodes. In yet other embodiments, there may be a defined set of chain capability configurations the training module 412 can select for training, and the training module 412 thus selects a chain capability configuration from this defined set (and avoids selection of a chain capability configuration that relies on a capability that is not commonly supported by the associated node).

With a chain capability configuration selected for training, at block 706 the training module 412 identifies one or more sets of training data for use in jointly training the DNNs of the DNN chain based on the selected chain capability configuration. That is, the one or more sets of training data include or represent data that could be provided as input to a corresponding DNN in online operation, and thus suitable for training the DNNs. To illustrate, this training data can include a stream of test data blocks of a data stream (e.g., video data blocks of a test video stream, audio data blocks of a test audio stream, measurement data blocks of a test measurement data stream, etc.), test sensor data consistent with the sensors included in the capability configuration under test, test RX or TX status information, capability parameters for accessories or other components of the test source/sink devices (e.g., resolution, sample rate, color gamut, parameter range, data formats, etc.), and the like.

With one or more training sets obtained, at block 708 the training module 412 initiates the joint training of the DNNs of the DNN chain. This joint training typically involves initializing the bias weights and coefficients of the various DNNs with initial values, which generally are selected pseudo-randomly, then inputting a set of training data at the TX processing module (e.g., source TX processing module 602) of the test source device, wirelessly transmitting the resulting output as a transmission to the RX processing module of the test source-facing infrastructure component (e.g., the source-facing RX processing module 606), transmitting the resulting output to the next RX DNN in the DNN chain, and so forth, until the output from the last DNN in the chain is obtained (that is, the output from the RX processing module (e.g., sink RX processing module 604) of the test sink device.

As is frequently employed for DNN training, feedback obtained as a result of the actual result output at the sink end of the DNN chain is used to modify or otherwise refine parameters of one or more DNNs of the chain, such as through backpropagation. Accordingly, at block 710 the managing component 136 and/or the DNN chain itself obtains feedback for the transmitted training set. This feedback can be implemented in any of a variety of forms or combinations of forms. In some embodiments, the feedback includes objective feedback, such as the training module 412 or other training module determining an error between the actual result output and the expected result output, and backpropagating this error throughout the DNNs of the DNN chain. The obtained objective feedback can also include evaluation metrics on some aspect of the signals as they traverse one or more links in the DNN chain. For example, relative to the RF aspects of the signaling, the objective feedback can include metrics such as such as block error rate (BER), signal-to-noise ratio (SNR), signal-to-interference-plus-noise ratio (SINR), and the like. The objective feedback can also include objective quality assessment metrics pertaining to the quality of the data content itself. For example, in the context of streaming video in which the processing by the DNN chain includes a form of lossy compression, the training data set can include one or more video frames and thus the objective feedback on the training data set can include peak SNR (PSNR) values based on comparisons of the recovered video frames at the test sink device relative to their original counterpart image frames in the training data set.

In some embodiments, the feedback obtained from a training iteration on the DNN chain using a training data set can include subjective user feedback when the streamed data is presented or otherwise “consumed” by a user in some form. For example, in the example context of a test video stream, the user can provide subjective feedback indicative of the user's perceived quality of the video content as presented at the test sink device. This feedback can be obtained through an overt query, such as presenting the user with one or more requests to rate some quality aspect of the presented test video content at the test sink device. This feedback also can be obtained indirectly through observation of the user's interaction with the playback of the test video content, such as through observation of the user changing the contrast settings, playback resolution settings, and the like. At block 712, the objective and/or subjective feedback obtained as a result of the transmission of the test data set through the DNN chain and presentation or other consumption of the resulting output at the test sink device is then used to update various aspects of one or more DNNs of the DNN chain, such as through backpropagation of the error so as to change weights, connections, or layers of a corresponding DNN, or through managed modification by the managing component 136 in response to such feedback. The training process of blocks 706-712 is then performed for the next set of training data selected at the next iteration of block 706, and repeats until a certain number of training iterations have been performed or until a certain minimum error rate has been achieved.

As a result of the joint (or individual) training of the neural networks along the neural network chain between a test source device and test sink device, each neural network has a particular neural network architectural configuration, or DNN architectural configuration in instances in which the implemented neural networks are DNNs, that characterizes the architecture and parameters of corresponding DNN, such as the number of hidden layers, the number of nodes at each layer, connections between each layer, the weights, coefficients, and other bias values implemented at each node, and the like. Accordingly, when the joint or individual training of the DNNs of DNN chain for a selected chain configuration is complete, at block 714 some or all of the trained DNN configurations are distributed to the nodes in the system 100, and each node stores the resulting DNN configurations of their corresponding DNNs as a DNN architectural configuration. In at least one embodiment, the DNN architectural configuration can be generated by extracting the architecture and parameters of the corresponding DNN, such as the number of hidden layers, number of nodes, connections, coefficients, weights, and other bias values, and the like, at the conclusion of the joint training.

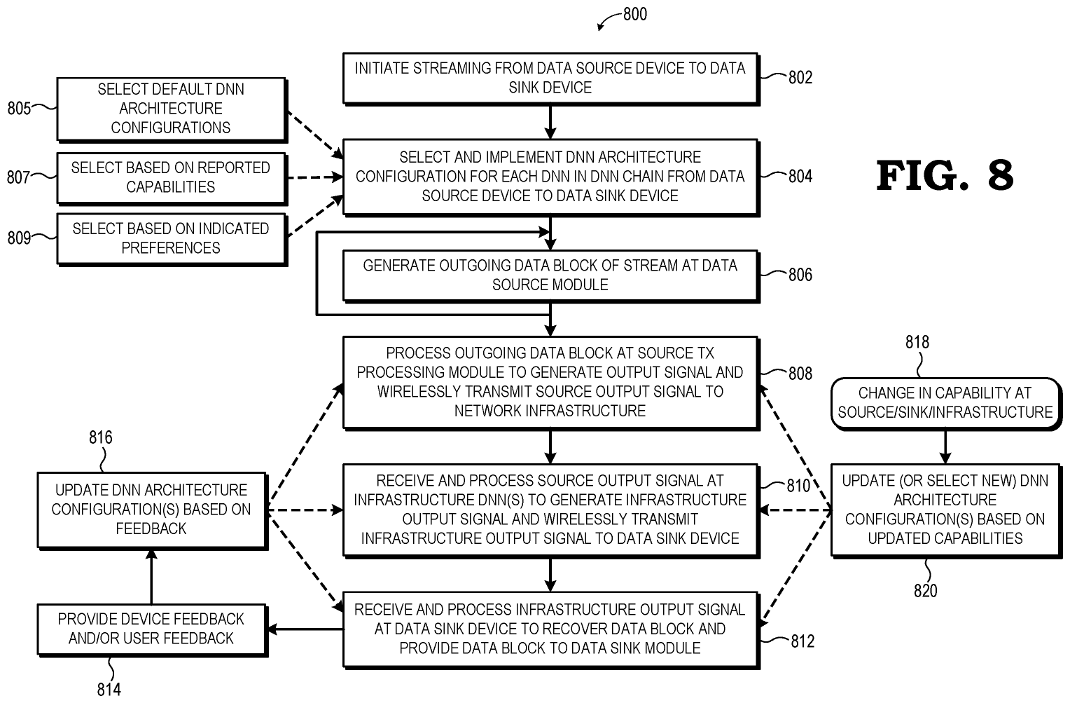

In the event that there are one or more other chain configurations remaining to be trained, then the method 700 returns to block 704 for the selection of the next chain configuration to be jointly trained, and another iteration of the subprocess of blocks 704-714 is repeated for the next chain configuration selected by the training module 412. Otherwise, if the DNNs of the DNN chain have been jointly trained for all intended chain configurations, then method 700 completes and the system 100 can shift to supporting RF-based transmission of streamed data between the devices 102 using the trained DNNs, as described below with reference to FIGS. 8-10.

As noted above, the joint training process can be performed using offline test nodes (that is, while no active communications of control information or user-plane data are occurring) or while the actual nodes of the intended transmission path are online (that is, while active communications of control information or user-plane data are occurring). Further, in some embodiments, rather than training all of the DNNs jointly, in some instances, a subset of the DNNs can be trained or retrained while other DNNs are maintained as static. To illustrate, the neural network manager 410 may detect that a particular processing module is operating inefficiently or incorrectly due to, for example, the presence of an undetected interferer in proximity to the node implementing the processing module or in response to a previously unreported loss of accessory capability, and thus the neural network manager 410 may schedule individual retraining of the DNN(s) of the that processing module while maintaining the other DNNs of the other processing modules of the nodes in their present configurations.

Further, it will be appreciated that, although there may be a wide variety of nodes supporting a large number of capability configurations, many different nodes may support the same or similar capability configuration. Thus, rather than have to repeat the joint training for every node that is incorporated into a transmission path for a data stream, following joint training of a representative test node the test node can transmit a representation of its trained DNN architectural configuration for a capability configuration to the managing component 136, and the managing component 136 can store the DNN architectural configuration and subsequently transmit it to other nodes that support the same or similar capability configuration for implementation in the DNNs of the transmission path.

Moreover, the DNN architectural configurations often will change over time as the corresponding nodes operate using the DNNs. Thus, as operation progresses, the neural network management module of a given node can be configured to transmit a representation of the updated architectural configurations of one or more of the DNNs employed at that node, such as by providing the updated gradients and related information, to the managing component 136 in response to a trigger. This trigger may be the expiration of a periodic timer, a query from the managing component 136, a determination that the magnitude of the changes has exceeded a specified threshold, and the like. The managing component 136 then incorporates these received DNN updates into the corresponding DNN architectural configuration and thus has an updated DNN architectural configuration available for distribution to the nodes in the transmission path as appropriate.

FIG. 8 illustrates an example method 800 for transmitting a data stream from the data source device 102-1 to the data sink device 102-2 using an end-to-end DNN chain extending along the transmission path from the data source device 102-1 through the network infrastructure 104 to the data sink device in accordance with some embodiments. Method 800 initiates at block 802 with the data source device 102-1 signaling the initiation of the data stream for transmission to the data sink device 102-2. In some embodiments, such as in cellular implementations that rely on an IMS service or other application server located in the network infrastructure 104 connecting the two devices 102, the initiation of a data stream can be indicated by the devices 102 registering with the IMS service or application server so as to arrange for the IMS service or application to provide suitable support for the data stream.

In response to an indication that a data stream is to be transmitted, the managing component 136 identifies the transmission path intended for the data stream and identifies the nodes along the transmission path. With the nodes so identified, at block 804 the managing component 136 selects a DNN architectural configuration to be implemented by some or all of the DNNs along the DNN chain formed by the processing modules of the nodes in the transmission path and transmits a configuration command to each impacted node to direct the node to implement the selected DNN architectural configuration for its corresponding DNN. In other embodiments, some or all of the nodes are configured to select their own DNN architectural configurations, rather than relying on the managing component 136 to do so. In either approach, the particular DNN architectural configuration selected for implementation for a DNN in the DNN chain can be determined using any of a variety of approaches. As represented by block 805, each DNN may have a default DNN architectural configuration, which may be associated with the type of data being streamed or other characteristic of the data stream, based on the RAT or other interface type supported by the DNN, and the like. For example, each node may have a default DNN initially implemented for any type of audio data stream. Alternatively, as represented by block 807, the DNN architectural configuration implemented for a DNN in the DNN chain may be based on the reported capabilities of the node implementing the DNN, the reported capabilities of one or more other nodes in the transmission path, or a combination thereof. For example, the data source device 102-1 may report a capability to support millimeter wave (mmWave) 5G NR RAT and an ability to generate a video stream with a 12-bit pixel depth and the data sink device 102—may report a capability to support sub-6 5G NR RAT and an ability to display video content with a 12-bit pixel depth, and thus the managing component 136 directs the data source device 102-1 to implement a particular DNN architectural configuration for the source TX processing module 602 that has been trained to channel encode for mmWave RAT transmission and data encode for 12-bit pixel depth, directs the source-facing RX processing module 606 of the source-facing infrastructure component 108-1 to implement a particular DNN architectural configuration that has been trained to channel decode for mmWave RAT transmission, directs the sink-facing TX processing module 608 of the sink-facing infrastructure component 108-2 to implement a DNN architectural configuration that has been trained to channel encode for sub-6 RAT transmission, and directs the sink RX processing module 604 to implement a DNN architectural configuration that has been trained to channel decode for sub-6 RAT transmissions and to data decode for 12-bit pixel depth. Still further, as represented by block 809 the particular DNN architectural configuration implemented by one or more DNNs may be initially selected based on one or more preferences indicated by a user or user device, such as a user-indicated preference for power conservation over performance, a user-indicated preference for a particular capability parameter (e.g., image resolution or frame rate), and the like.

With the DNNs of the DNN chain being initially configured, the data streaming can begin. Accordingly, at block 806 the data source module 122 generates an outgoing data block (e.g., outgoing data block 624, FIG. 6) for the data stream. At block 808, the source TX processing module 602 receives the data block as an input, along with one or more other inputs, such as sensor data from sensors of the data source device 102-1, capability data regarding capabilities of one or more nodes, present transmission parameters of the RF antenna interface 204 of the data source device 102-1, and from these inputs generates an output signal that represents a source encoded (compressed) and channel encoded representation of the outgoing data block that is suitable for digital-to-analog conversion and RF transmission by the RF antenna interface 204 to the source-facing infrastructure component 108-1 of the network infrastructure 104.

At block 810, this output signal is received by the source-facing RX processing module 606 of the source-facing infrastructure component 108-1 as an input along with one or more other inputs, such as sensor data, present RX parameters, and the like, and the one or more DNNs of the source-facing RX processing module 606 generate a corresponding output signal based on these inputs. The information of this output signal is then processed by any subsequent DNNs in the DNN chain present in the nodes of the network infrastructure 104 as described above. At the other side of the network infrastructure 104, a signal representing this information is input to the sink-facing TX processing module 608, along with sensor data, present TX parameters, capability information, and the like, and the one or more DNNs of the sink-facing TX processing module 608 processes these inputs to generate an output signal, referred to herein as an “infrastructure output signal”, that has been channel encoded in a manner suitable for digital-to-analog conversion and RF transmission to the data sink device 102-2.

At block 812, the RF antenna interface 204 of the data sink device 102-2 receives the RF transmission and performs initial processing to generate a digital output representative of the infrastructure output signal, and this digital output is provided as an input to the sink RX processing module 604, along with other inputs such as sensor data from the sensors of the data sink device 102-2 present RX parameters, capability information, and the like. The one or more DNNs of the sink RX processing module 604 process these inputs to effectively channel decode the signal and destination decode the underlying data to generate an incoming data block (e.g., incoming data block 646, FIG. 6) that represents a recovered version of the data of the outgoing data block generated at block 806. The incoming data block then is provided to the data sink module 126 for further processing.

The process of blocks 806 to 812 can be repeated for each outgoing data block generated by the data source module 122 for inclusion in the data stream being transmitted. During this iterative streaming process, at block 814 the data sink device 102-2 may provide feedback regarding the received data, or the received signal representing the received data. As explained above, this feedback can be provided as objective feedback, such as in the form of a BER, SNR, PSNR, or other quantifiable error parameter. Additionally or alternatively, this feedback can include subjective feedback obtained from the user through explicit solicitation of user feedback (such as through a query regarding the user's QoE perceptions), through observation of the user's control or interaction with the content of the data stream or its presentation, and the like. At block 816, this feedback is used by the managing component 136 or other infrastructure component to update the DNN architecture configuration of one or more DNNs in the chain, such as via backpropagation that modifies aspects of the DNN architectural configurations presently in use, by triggering the managing component 136 to switch out one DNN architectural configuration for another, or a combination thereof.

Further, during the streaming process, capabilities of one or more nodes in the transmission path may change in a manner that impacts the processing performed by the end-to-end DNN chain. For example, a video stream may initiate with the data sink device 102-1 connected to an external display panel and thus the generation of the video data and its subsequent processing through the DNN chain may be configured based on the capabilities of the external display panel. However, partway through the streaming process, the user may switch to using the built-in display panel of the data sink device 102-2, and this may necessitate a change in one or more of the DNNs to accommodate this change. Accordingly, when a capability of a node has changed (as represented by block 818), the managing component 136, or the affected node itself, updates the one or more DNNs impacted by the capability change to accommodate the capability change, or selects a replacement DNN architectural configuration for the affected DNN, or a combination thereof, at block 820.

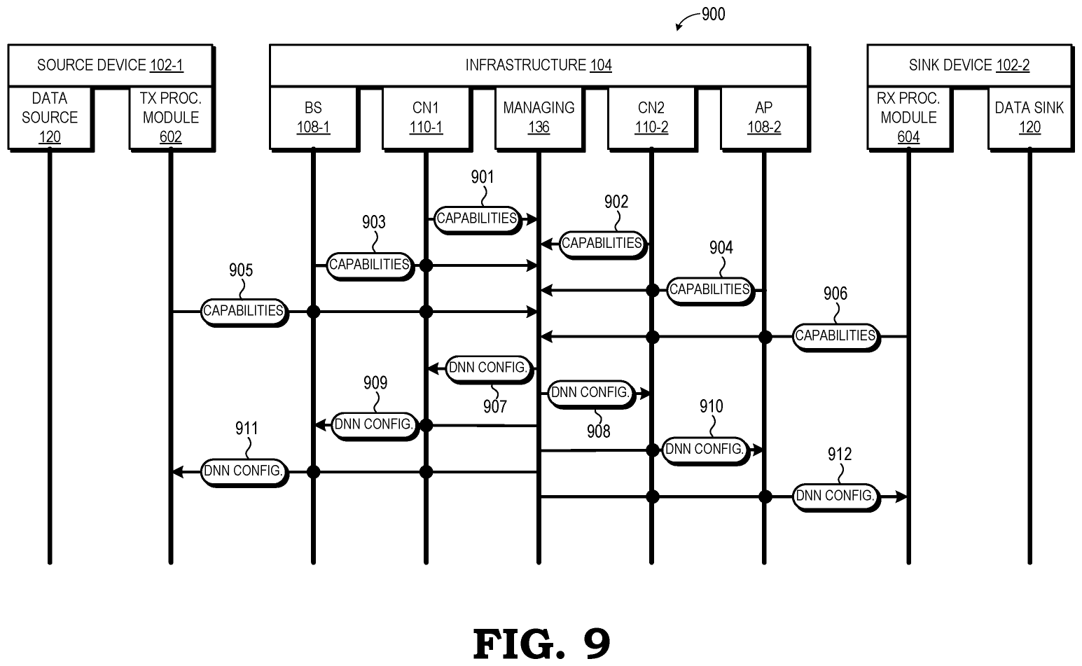

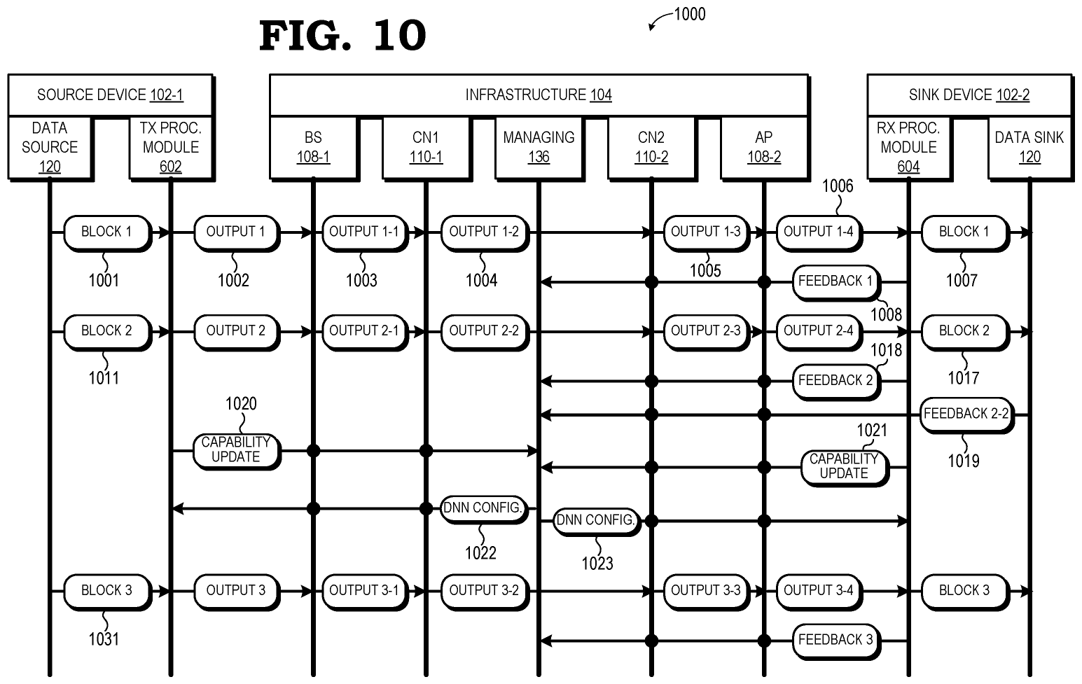

Turning now to FIGS. 9 and 10, transaction (ladder) diagrams depicting an example of the configuration and operation of an end-to-end DNN chain for encoded, wireless transmission of a data stream are shown in accordance with at least one embodiment. To facilitate understanding, the process represented by FIGS. 9 and 10 is described in the example context of FIG. 1 in which the source-facing infrastructure component 108-1 is a cellular BS and the sink-facing infrastructure component 108-2 is a WiFi AP. The example context used herein further utilizes a video stream as the data stream. However, it will be appreciated that the principles described apply equally to other types of data streams, and further apply equally to other combinations of device-facing infrastructure components, such as an all-BS configuration, an all WiFi AP configuration, a WiFi AP as the source-facing infrastructure component and a cellular BS as the sink-facing infrastructure component, and the like.

FIG. 9 illustrates a transaction diagram 900 for the initial configuration of the DNN chain for implementing particular DNN architectural configurations trained in accordance with selected chain configurations. In the illustrated example, the managing component 136 is responsible for selecting DNN architectural configurations for the DNNs of the end-to-end DNN chain. Accordingly, the process begins with the nodes in the DNN reporting their capabilities to the managing component 136. This includes transmission of capabilities messages 901, 902, 903, 904, 905, and 906 from the CN1 110-1, the CN2 110-2, the BS 108-1, the AP 108-2, the data source device 102-1, and the data sink device 102-2, respectively. The capability information provided by the BS 108-1, the AP 108-2, and the devices 102-1, 102-2 can include, for example, RAT capabilities, power capabilities, processing capabilities, and the like. For the devices 102-1, 102-2, the capabilities information further can include accessory capability information, such as the presence of a camera used at the data source device 102-1 to capture the video content of the video stream and its parameters, the presence of an HMD used at the data sink device 102-2 to display the video content, and the like.

Based on the received capability information and other considerations, such as indicated preferences, predefined default settings, and the like, the managing component 136 identifies the DNN architectural configurations to be employed at the one or more DNNs of each of the nodes and transmits a configuration message to each of the nodes identifying or otherwise indicating the DNN architectural configuration(s) to be employed by that node, including configuration messages 907, 908, 909, 910, 911, and 912 transmitted to the CN1 110-1, the CN2 110-2, the BS 108-1, the AP 108-2, the data source device 102-1, and the data sink device 102-2, respectively. In response to receiving a configuration message, the corresponding node implements the identified DNN architectural configurations at its corresponding DNNs. At this point, the end-to-end DNN chain in the transmission path has been initialized and is ready to begin the data streaming process.

Transaction diagram 1000 of FIG. 10 illustrates this data streaming process from the configuration of diagram 900 of FIG. 9. The streaming process begins with the data source module 122 generating a first data block 1001 (Block 1) of video content which is processed by the source TX processing module 602 to generate an output signal 1002 (Output 1) that is a source encoded and channel encoded representation of the first data block 1001, and which is then wirelessly transmitted to the BS 108-1. The one or more processing modules of the BS 108-1 use the output signal 1002 as an input to generate a corresponding output signal 1003 (Output 1-1) that is transmitted to the CN1 110-1. The one or more processing modules of the CN1 110-1 process the output signal 1003 to generate an output signal 1004 (Output 1-2), which is transmitted to the CN2 110-2 via the one or more networks 112. The one or more processing modules of the CN2 110-2 process the output signal 1004 to generate a corresponding output signal 1005 (Output 1-3) that is transmitted to the AP 108-2. The one or more processing modules of the AP 108-2 in turn process the output signal 1005 to generate an output signal 1006 (Output 1-4) that is wirelessly transmitted to the data sink device 102-2. At the data sink device 102-2, the sink RX processing module 604 receives the output signal 1006 as an input, and further may receive sensor data, present RX parameters, capability information, and other data as inputs, and from these inputs generate an output data block 1007 that represents a data decoded and channel decoded version of the data represented in the output signal 1006, thus representing a recovered representation of the outgoing data block 1001 generated by the data source module 122. This recovered data block 1007 then is provided to the data sink module 126, which processes the data for presentation of the corresponding video content to the user via a display panel. In this example, the user has not yet provided any subjective feedback, and thus the only feedback provided back to the managing component 136 at this point is object feedback 1108 (Feedback 1) representing a quantifiable aspect of the data or the signal used to convey the data, such as an SNR value or an average contrast value.

This process is repeated for the transmission of the next outgoing data block 1102 (Block 2) generated by the data source module 122, resulting in a recovered data block 1017 output by the sink RX processing module 604 for use by the data sink module 126 in displaying the corresponding video content to the user. As with the recovered data block 1007, for the recovered data block 1017 the data sink device 102-2 can provide objective feedback 1018 to the managing component 136. Further, at this point the user has viewed a sufficient amount of the video content to provide subjective feedback 1019 indicating the user's subjective impression of the QoE of the streaming process up to this point.

Further, following transmission of data block 1011, the capabilities of both the data source device 102-1 and the data sink device 102-2 change. In this example, the data source device 102-1 is moved from wall outlet power to battery-only power, which is reported to the managing component 136 as capability update message 1020, and the data sink device 102-2 is disconnected from an external flat panel television and thus is switching to use of a built-in display panel, which is reported to the managing component 136 as capability message 1021. In response to these reported capability changes and in response to the objective and subjective feedback provided in response to the transmission of data blocks 1001 and 1011, the managing component 136 determines that a switch of the DNN architectural configurations of both the data source device 102-1 and the data sink device 102-2 is in order to accommodate the capability changes and to provide improved QoE. The managing component 136 thus sends a DNN configuration message 1022 to the source TX processing module 602 to direct the switch to its newly-selected DNN architectural configuration, and also sends a DNN configuration message 123 to the sink RX processing module 604 to direct the switch to its newly-selected DNN architectural configuration. With the new DNN architectural configurations implemented at the source end and sink end of the DNN chain, the revised end-to-end DNN chain can be used to transmit the next data block 1031 (Block 3) generated by the data source module 122 from the data source device 102-1 to the data sink device 102-2 via the updated DNN chain, and receive corresponding feedback, in the same manner as described above for data blocks 1001 and 1011.

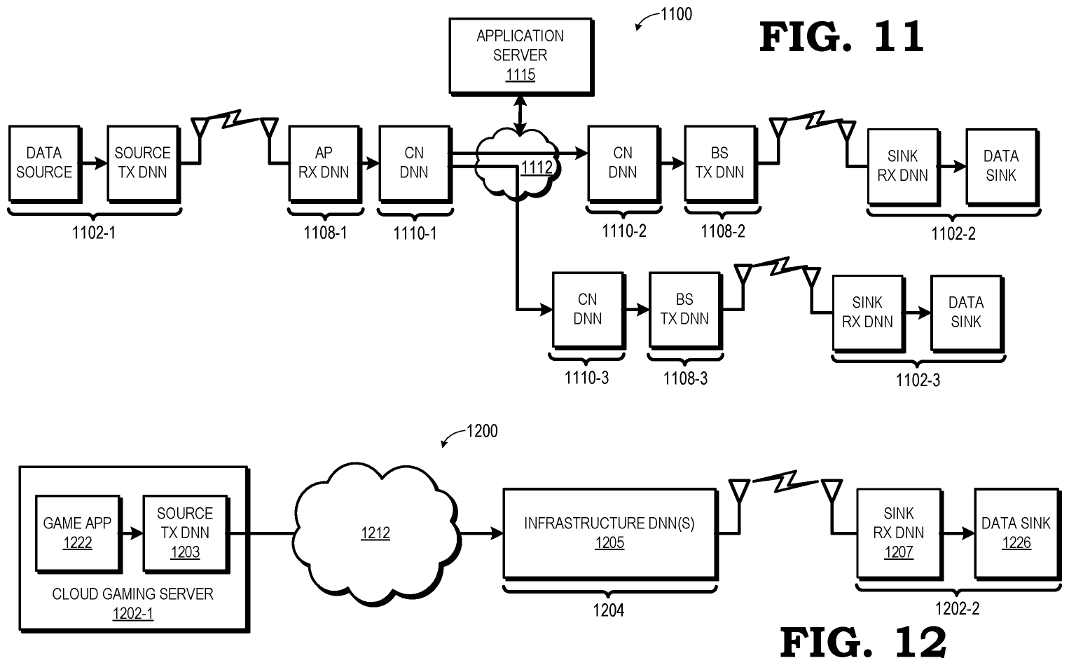

Although FIGS. 1-10 are described above in the context of the system 100 in which there is a single data sink device and in which both the source end and sink end of the transmission path involve wireless transmission, and thus a DNN that provides both data encoding and channel encoding at the source side and a DNN that provides both data decoding and channel decoding at the sink side, the techniques described herein are not limited to these particular aspects. To illustrate, FIG. 11 depicts an alternative system 1100 in which a data source device 1102-1 streams data to multiple data sink devices, such as the illustrated two data sink device 1102-2 and 1102-3 via a network infrastructure 1104 that includes a WLAN AP 1108-1 wirelessly connected to the data source device 1102-1, a cellular BS 1108-2 wirelessly connected to the data sink device 1102-2, and a cellular BS 1108-3 wirelessly connected to the data sink device 1102-3, and CNs 1110-1, 1110-2, 1110-3 interconnecting the AP 1108-1, BS 1108-2, and BS 1108-3 via one or more non-core networks 1112. The network infrastructure 1104 further can include an application server 1115 to support this multiple destination streaming. In this example, it will be appreciated that the system 1100 includes multiple transmission paths, and thus the data streaming process involves the use of DNNs that form an end-to-end DNN tree. However, the techniques described above for the training, configuration, and use of an end-to-end DNN chain for streaming data from a data source device to a single data sink device apply equally to an end-to-end DNN tree variation, such that each route within the end-to-end DNN tree can be separately joint-trained using the same process described above, and the DNN architectural configurations implemented such that DNN architectural configurations for DNNs that are present in both routes are selected in a manner that accommodates both routes.

Further, FIG. 12 illustrates an example remote cloud gaming system 100 employing the techniques described above in accordance with some embodiments. In the illustrated cloud gaming system 1200, a cloud gaming server 1202-1 is connected to a user device 1202-2 via a non-core network 112 (e.g., the Internet) and a network infrastructure 1204 including one or more core networks and a base station (not shown) wirelessly connected to the user device 1202-2. In this example, a video game application 1222 (one embodiment of the data source module 122) executes an instance of a video game, which results in the generation of a video stream and an audio stream representative of the video content and the audio content, respectively, of the game play of the video game application 1220. The audio and video packets of these streams are then provided to one or more source TX DNNs 1203 of the cloud gaming server 1202-1, which process this input along with other inputs to generate data encoded representations of the audio data and video data, and which are transmitted to the network infrastructure 1204 via the network 1212. One or more infrastructure DNNs 1205 in the network infrastructure 1204 then process successive signals representative of the underlying information to ultimately generate channel encoded output signals that are wirelessly transmitted to the user device 1202-2, whereupon the output signals are processed along with other inputs by a sink RX DNN 1207 to generate corresponding data decoded and channel decoded representations of the corresponding video content and audio content, which then may be provided to a data sink module 1226 (e.g., a web browser) to present the audio and video content to the user.

The various aspects of the present disclosure may also be better understood with reference to the following examples, which may be implemented individually or in various combinations:

Example 1: A computer-implemented method, in a data source device, including:
receiving a first data block of a data stream as an input to a transmitter neural network of the data source device;
generating, at the transmitter neural network, a first output based on the first data block, the first output representing a data encoded and channel encoded version of the first data block; and
controlling a radio frequency (RF) antenna interface of the data source device based on the first output to transmit a first RF signal representative of the data encoded and channel encoded version of the first data block.
Example 2: The method of Example 1, further including:
selecting, at the data source device, a first neural network architectural configuration from a plurality of neural network architectural configurations based on at least one of: one or more capabilities of at least one of the data source device or a data sink device configured to receive the data stream; or a user-indicated preference; and
wherein generating the first output includes generating the first output at the transmitter neural network based on the first neural network architectural configuration of the transmitter neural network.
Example 3: The method of Example 2, further including:
implementing a first neural network architectural configuration selected from a plurality of neural network architectural configurations for the transmitter neural network responsive to a command from an infrastructure component of a network infrastructure; and
wherein generating the first output includes generating the first output at the transmitter neural network based on the first neural network architectural configuration of the transmitter neural network.
Example 4: The method of Example 3, further including:
receiving the command from a network infrastructure component responsive to provision of one or more representations of one or more capabilities of at least one of the data source device or the data sink device to the infrastructure component.
Example 5: The method of any of Examples 2 through 4, further including:
modifying the transmitter neural network to implement a second neural network architectural configuration responsive to a change in capabilities of at least one of the data source device or the data sink device;
receiving a second data block of a data stream as an input to the transmitter neural network;
generating, at the transmitter neural network, a second output based on the second data block and using the second neural network architectural configuration, the second output representing a data encoded and channel encoded version of the second data block; and controlling the RF antenna interface of the data source device based on the second output to transmit a second RF signal representative of the data encoded and channel encoded version of the second data block.
Example 6: The method of Example 5, further including:
receiving a command from an infrastructure component of a network infrastructure responsive to provision of one or more representations of the change in capabilities to the infrastructure component, the command instructing the data source device to implement the second neural network architectural configuration.
Example 7: The method of any preceding Example, wherein generating the first output includes generating the first output at the transmitter neural network further based on at least one of: sensor data input to the transmitter neural network from one or more sensors of the data source device; a current operational parameter of the RF antenna interface; and capability information representing current capabilities of at least one of the data source devices or a data sink device.
Example 8: The method of any preceding Example, further including:
participating in joint training of a neural network architectural configuration for the transmitter neural network with at least one of: a neural network architectural configuration for a receiver neural network of a data sink device; and a neural network architecture configuration for an infrastructure component of a network infrastructure in a transmission path between the data source device and the data sink device.
Example 9: A computer-implemented method, in a data sink device, including:
receiving, at a radio frequency (RF) antenna interface of the data sink device, a first RF signal representative of a data encoded and channel encoded version of a first data block of a data stream;
providing a first input representative of the first RF signal as an input to a receiver neural network of the data sink device;
generating, at the receiver neural network, a first recovered data block representing a recovered channel decoded and data decoded version of the first data block; and
providing the first recovered data block for processing at one or more software applications of the data sink device.
Example 10: The method of Example 9, further including:
selecting, at the data sink device, a first neural network architectural configuration from a plurality of neural network architectural configurations based on at least one of: one or more capabilities of at least one of the data sink device or a data source device; or a user-indicated preference; and
wherein generating the first recovered data block includes generating the first recovered data block at the receiver neural network based on the first neural network architectural configuration of the receiver neural network.
Example 11: The method of Example 10, further including:
receiving a command from an infrastructure component of a network infrastructure responsive to provision of one or more representations of one or more capabilities of at least one of the data sink device or a data source device to an infrastructure component of a network infrastructure; and
implementing the first neural network architectural configuration for the receiver neural network responsive to the command.
Example 12: The method of Example 10, further including:
modifying the receiver neural network to implement a second neural network architectural configuration responsive to a change in capabilities of at least one of the data sink device or the data source device;
receiving, at the RF antenna interface, a second RF signal representative of a data encoded and channel encoded version of a second data block of the data stream;
providing a second input representative of the second RF signal as an input to a receiver neural network of the data sink device;
generating, at the receiver neural network, a second recovered data block representing a recovered channel decoded and data decoded version of the second data block; and
providing the second recovered data block for processing at the one or more software applications.
Example 13: The method of Example 12, further including:
receiving a command from an infrastructure component of a network infrastructure responsive to provision of one or more representations of the change in capabilities to the infrastructure component, the command instructing the data sink device to implement the second neural network architectural configuration.
Example 14: The method of any of Examples 9 to 13, wherein generating the first recovered data block includes generating the first recovered data block at the receiver neural network further based on at least one of: sensor data input to the receiver neural network from one or more sensors of the data sink device; a current operational parameter of the RF antenna interface; or capability information representing current capabilities of at least one of the data sink device or a data source device.
Example 15: The method of any of Examples 9 to 14, further including:
participating in joint training of a neural network architectural configuration for the receiver neural network with at least one of: a neural network architectural configuration for a transmitter neural network of a data source device; and a neural network architecture configuration for an infrastructure component of a network infrastructure in a transmission path between the data source device and the data sink device.
Example 16: The method of any of Examples 9 to 15, further including:
providing feedback to an infrastructure component of a network infrastructure in a transmission path between the data sink device and a data source device responsive to generating the first recovered data block, the feedback representing a quality metric for the first recovered data block.
Example 17: The method of Example 16, wherein the feedback includes an objective quality metric generated by the data sink device independent of user input.
Example 18: The method of either of Examples 16 or 17, wherein the feedback includes a subjective quality metric based on user input from a user of the data sink device.
Example 19: The method of any of Examples 16 to 18, further including:
receiving, from the infrastructure component, an updated neural network architectural configuration for implementation at the receiver neural network responsive to providing the feedback to the infrastructure component.
Example 20: A computer-implemented method, in an infrastructure component of a network infrastructure, including:
configuring a data source device to implement a first neural network architectural configuration for a transmitter neural network of the data source device, the transmitter neural network configured to generate, for each input data block of a data stream generated at the data source device, a corresponding output for transmission by a radio frequency (RF) antenna interface of the data source device, the corresponding output representing a data encoded and channel encoded version of the input data block; and
configuring a data sink device to implement a second neural network architectural configuration for a receiver neural network of the data sink device, the receiver neural network configured to generate, for each input from an RF antenna interface of the data sink device, a corresponding data block for provision to one or more software applications of the data sink device, the corresponding data block representing a recovered channel decoded and data decoded version of a corresponding data block of the data stream.
Example 21: The method of Example 20, further including:
configuring at least one infrastructure component in a transmission path between the data source device and the data sink device to implement a third neural network architectural configuration for a neural network of the infrastructure component.
Example 22: The method of Example 21, wherein configuring the at least one infrastructure component includes configuring the at least one infrastructure component to implement the third neural network architectural configuration responsive to receiving capability information from at least one of the data source device, the data sink device, or an infrastructure component of the network infrastructure.
Example 23: The method any of Examples 20 to 22, wherein:
configuring the data source device to implement the first neural network architectural configuration includes configuring the data source device to implement the first neural network architectural configuration responsive to receiving capability information from at least one of the data source device, the data sink device, or an infrastructure component of the network infrastructure; and
configuring the data sink device to implement the second neural network architectural configuration includes configuring the data sink device to implement the second neural network architectural configuration responsive to receiving capability information from at least one of the data source device, the data sink device, or an infrastructure component of the network infrastructure.
Example 24: The method of Example 23, further including at least one of:
configuring the data source device to implement a modified first neural network architectural configuration for the transmitter neural network responsive to receiving an indicator of a change of capabilities of at least one of the data source device, the data sink device, or an infrastructure component of the network infrastructure; and
configuring the data sink device to implement a modified second neural network architectural configuration for the transmitter neural network responsive to receiving an indicator of a change of capabilities of at least one of the data source device, the data sink device, or an infrastructure component of the network infrastructure.
Example 25: The method of any of Examples 20 to 24, further including:
receiving feedback from the data sink device responsive to the data sink device generating a recovered data block using the receiver neural network, the feedback representing a quality metric for the recovered data block;
determining a modified neural network architectural configuration based on the feedback; and
configuring at least one of the data sink device or the data source device to implement the modified neural network architectural configuration.
Example 26: The method of Example 25, wherein the feedback includes an objective quality metric generated by the data sink device independent of user input.
Example 27: The method of either of Examples 25 or 26, wherein the feedback includes a subjective quality metric based on user input from a user of the data sink device.
Example 28: The method of any of Examples 20 to 27, further including:
jointly training the first neural network architectural configuration and the second neural network architectural configuration.
Example 29: The method of any of Examples 1-8, 15, 16, and 20 to 28, wherein the data source device includes a user equipment.
Example 30: The method of any of Examples 1-8, 15, 16, and 20 to 28, wherein the data source device includes a server.
Example 31: The method of any of Examples 8 to 30, wherein the data sink device includes a user equipment.
Example 32: The method of any of any preceding Example, wherein the data stream includes a real-time data stream.
Example 33: The method of Example 32, wherein the real-time data stream includes an audio stream of a voice call.
Example 34: The method of Example 33, wherein the real-time data stream includes at least one of an audio stream or a video stream of a video call.
Example 35: The method of Example 32, wherein the data source device includes a remote video game server, the data sink device includes a user device, and the real-time data stream includes a rendered video stream.
Example 36: The method of any of Examples 1 to 8 and 20 to 30, wherein the transmitter neural network includes a deep neural network.
Example 37: The method of any of Examples 9 to 28, wherein the receiver neural network includes a deep neural network.
Example 38: The method of any of Examples 3, 5, 10, or 11, wherein the one or more capabilities include at least one of: a sensor capability; a processing resource capability; a power capability, an RF antenna interface capability; a data generation capability; a data consumption capability; and a device accessory capability.
Example 39: A device including:
a network interface;
at least one processor coupled to the network interface; and
a memory storing executable instructions, the executable instructions configured to manipulate the at least one processor to perform the method of any of Examples 20 to 28:
Example 40: A device including:
a radio frequency (RF) antenna interface;
at least one processor coupled to the RF antenna interface; and
a memory storing executable instructions, the executable instructions configured to manipulate the at least one processor to perform the method of any of Examples 1 to 19:

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method, in a data source device, comprising:
receiving a first data block of a data stream as an input to a transmitter neural network of the data source device, the transmitter neural network implementing a first neural network architectural configuration;
generating, at the transmitter neural network implementing the first neural network architectural configuration, a first output based on the first data block, the first output representing a data encoded and channel encoded version of the first data block;
controlling a radio frequency (RF) antenna interface of the data source device based on the first output to transmit a first RF signal representative of the data encoded and channel encoded version of the first data block to a data sink device; and
modifying the transmitter neural network to implement a second neural network architectural configuration responsive to a change in capabilities of at least one of the data source device or the data sink device.

2. The method of claim 1, wherein modifying the transmitter neural network to implement the second neural network architectural configuration is performed responsive to at least one of: a change in capability of the data source device; or a change in capability of the data sink device.

3. (canceled)

4. The method of claim 1, further comprising:
selecting, at the data source device, the first neural network architectural configuration from a plurality of neural network architectural configurations based on at least one of: one or more capabilities of at least one of the data source device or a data sink device configured to receive the data stream; or a user-indicated preference.

5. The method of claim 1, further comprising:
implementing the first neural network architectural configuration selected from a plurality of neural network architectural configurations for the transmitter neural network responsive to a command from an infrastructure component of a network infrastructure.

6. The method of claim 4, further comprising:
receiving a second data block of a data stream as an input to the modified transmitter neural network implementing the second neural network architectural configuration;
generating, at said transmitter neural network, a second output based on the second data block and using the second neural network architectural configuration, the second output representing a data encoded and channel encoded version of the second data block; and
controlling the RF antenna interface of the data source device based on the second output to transmit a second RF signal representative of the data encoded and channel encoded version of the second data block.

7. The method of claim 1 wherein generating the first output comprises generating the first output at the transmitter neural network further based on at least one of: sensor data input to the transmitter neural network from one or more sensors of the data source device; a present operational parameter of the RF antenna interface; or capability information representing present capabilities of at least one of the data source device or a data sink device.

8. A computer-implemented method, in a data sink device, comprising:
receiving, at a radio frequency (RF) antenna interface of the data sink device, a first RF signal from a data source device, the first RF signal representative of a data encoded and channel encoded version of a first data block of a data stream;
providing a first input representative of the first RF signal as an input to a receiver neural network of the data sink device, the receiver neural network implementing a first neural network architectural configuration;
generating, at the receiver neural network implementing the first neural network architectural configuration, a first recovered data block representing a recovered channel decoded and data decoded version of the first data block;
providing the first recovered data block for processing at one or more software applications of the data sink device; and
modifying the receiver neural network to implement a second neural network architectural configuration responsive to a change in capabilities of at least one of the data sink device or the data source device.

9. The method of claim 8, wherein modifying the receiver neural network to implement the second neural network architectural configuration is performed responsive to at least one of: a change in capability of the data source device; or a change in capability of the data sink device.

10. (canceled)

11. The method of claim 8, further comprising:
selecting, at the data sink device, the first neural network architectural configuration from a plurality of neural network architectural configurations based on at least one of: one or more capabilities of at least one of the data sink device or a data source device; or a user-indicated preference.

12. The method of claim 11, further comprising:
receiving, at the RF antenna interface, a second RF signal representative of a data encoded and channel encoded version of a second data block of the data stream;
providing a second input representative of the second RF signal as an input to the modified receiver neural network of the data sink device;
generating, at the receiver neural network, a second recovered data block representing a recovered channel decoded and data decoded version of the second data block; and
providing the second recovered data block for processing at the one or more software applications.

13. The method of claim 8 wherein generating the first recovered data block comprises generating the first recovered data block at the receiver neural network further based on at least one of: sensor data input to the receiver neural network from one or more sensors of the data sink device; a present operational parameter of the RF antenna interface; or capability information representing present capabilities of at least one of the data sink device or a data source device.

14. The method of any of claim 8, further comprising:
providing feedback, to a first infrastructure component of a network infrastructure in a transmission path between the data sink device and a data source device, a quality metric for the first recovered data block; and
in response to the feedback, receiving, from a second infrastructure component, an updated neural network architectural configuration for implementation at the receiver neural network.

15. The method of claim 14, wherein the feedback includes one or more of: an objective quality metric generated by the data sink device independent of user input; or a subjective quality metric based on user input from a user of the data sink device.

16. The method of claim 8, wherein the data sink device comprises a device configured to be wirelessly connected to a base station, wireless access point, or other component of an infrastructure network.

17. (canceled)

18. A computer-implemented method, in a first infrastructure component of a network infrastructure, comprising:
configuring a data source device to implement a first neural network architectural configuration for a transmitter neural network of the data source device, the transmitter neural network, implementing the first neural network architectural configuration, being configured to generate, for each input data block of a data stream generated at the data source device, a corresponding output for transmission by a radio frequency (RF) antenna interface of the data source device, the corresponding output representing a data encoded and channel encoded version of the input data block; and
configuring a data sink device to implement a second neural network architectural configuration for a receiver neural network of the data sink device, the receiver neural network, implementing the second neural network architectural configuration, being configured to generate, for each input from an RF antenna interface of the data sink device, a corresponding data block for provision to one or more software applications of the data sink device, the corresponding data block representing a recovered channel decoded and data decoded version of a corresponding data block of the data stream,
the method further comprising at least one of:
configuring the data source device to implement a modified neural network architectural configuration for the transmitter neural network responsive to receiving an indicator of a change of capabilities of at least one of the data source device, the data sink device, or an infrastructure component of the network infrastructure; and
configuring the data sink device to implement a modified neural network architectural configuration for the receiver neural network responsive to receiving an indicator of a change of capabilities of at least one of the data source device, the data sink device, or an infrastructure component of the network infrastructure.

19. The method of claim 18, further comprising:
configuring a second infrastructure component in a transmission path between the data source device and the data sink device to implement a third neural network architectural configuration for a neural network of the second infrastructure component, the second infrastructure component including the first infrastructure component or another infrastructure component.

20. The method of claim 19, wherein configuring second infrastructure component comprises configuring second infrastructure component to implement the third neural network architectural configuration responsive to receiving capability information from at least one of the data source device, the data sink device, or an infrastructure component of the network infrastructure.

21. (canceled)

22. The method of claim 19, wherein:
configuring the data source device to implement the first neural network architectural configuration comprises configuring the data source device to implement the first neural network architectural configuration responsive to receiving capability information representing one or more capabilities from at least one of the data source device, the data sink device, or an infrastructure component of the network infrastructure; and
configuring the data sink device to implement the second neural network architectural configuration comprises configuring the data sink device to implement the second neural network architectural configuration responsive to receiving capability information representing one or more capabilities from at least one of the data source device, the data sink device, or an infrastructure component of the network infrastructure.

23. The method of claim 19, further comprising:
receiving feedback from the data sink device responsive to the data sink device generating a recovered data block using the receiver neural network, the feedback representing a quality metric for the recovered data block;
determining a modified neural network architectural configuration based on the feedback; and
configuring at least one of the data sink device or the data source device to implement the modified neural network architectural configuration.

24. (canceled)

25. The method of claim 1, wherein the data stream comprises a real-time data stream, and wherein at least one of:
the real-time data stream comprises one of: an audio stream of a voice call or an audio stream or a video stream of a video call; or
the data source device comprises a remote video game server, the data sink device comprises a user device, and the real-time data stream comprises a rendered video stream.

26. The method of claim 22, wherein the one or more capabilities comprise at least one of: a sensor capability; a processing resource capability; a power capability, an RF antenna interface capability; a data generation capability; a data consumption capability; and a device accessory capability.

27. A device comprising:
a network interface;
at least one processor coupled to the network interface; and
a memory storing executable instructions, the executable instructions configured to manipulate the at least one processor to perform the method of claim 18.

28. A device comprising:
a radio frequency (RF) antenna interface;
at least one processor coupled to the RF antenna interface; and
a memory storing executable instructions, the executable instructions configured to manipulate the at least one processor to perform the method of claim 1.
